(19) United States
(12) Patent Application Publication
(10) Pub. No.: US 2013/0002963 A1
(43) Pub. Date: Jan. 3, 2013

(54) DISPLAY DEVICE AND TELEVISION RECEIVER

(76) Inventor: Masashi Yokota, Osaka-shi (JP)

(21) Appl. No.: 13/636,285

(22) PCT Filed: Feb. 9, 2011
(86) PCT No.: PCT/JP2011/052706

§ 371 Date: Sep. 20, 2012

(30) Foreign Application Priority Data
Mar. 25, 2010 (JP) 2010-070034

(51) Int. Cl. G09F 13/04; G02F 1/13357; H04N 5/44; F21V 8/00

(52) U.S. Cl. 348/728; 362/97.3; 362/602; 349/69; 348/725; 348/E05.096

(57) ABSTRACT

It is an object of the present invention to obtain high brightness and high color reproducibility in a liquid crystal display device. A liquid crystal display device 10 according to the present invention includes a liquid crystal panel 11 and a backlight unit 12. The liquid crystal panel 11 includes a pair of substrates 11a and 11b, and a liquid crystal layer 11c. The liquid crystal layer 11C includes liquid crystal between the substrates 11a and 11b. The liquid crystal is a substance having optical characteristics that vary with application of an electric field. The backlight unit 12 includes a light source. The back light unit 12 is configured to irradiate light onto the liquid crystal panel 11. At least one of the substrates 11a and 11b of the liquid crystal panel 11 includes a color filter 19 with a plurality of color sections R, G, B, and Y that exhibit the colors of blue, green, red, and yellow, respectively. The backlight unit 12 includes LEDs 24 as the light source. Each LED 24 includes an LED element as a light emitting source and a phosphor configured to emit light when excited by the light from the LED element. The phosphor includes at least two types of phosphors with different dominant emission wavelengths in a range of 480 nm to 580 nm.

### TECHNICAL FIELD

The present invention relates to a display device and a television receiver.

### BACKGROUND ART

Generally, a liquid crystal panel as a main component of a liquid crystal display device includes a pair of glass substrates between which liquid crystal is sealed in. One of the glass substrates is an array substrate on which active elements, such as TFTs, are provided. The other substrate is a CF substrate on which a color filter and the like are provided. On an inner surface of the CF substrate opposed to the array substrate, a color filter including a plurality of color sections corresponding to the respective colors of red, green, or blue is formed. The color sections are arranged side by side correspondingly to the respective pixels of the array substrate. Between the color sections, a light blocking layer preventing mixing of the colors is provided. Light irradiated by a backlight and transmitted through the liquid crystal has its wavelength selectively transmitted through the corresponding red, green, or blue color section in the color filter such that an image can be displayed on the liquid crystal panel.

In order to increase display quality of the liquid crystal display device, it is effective to increase its color reproducibility, for example. For this purpose, an additional color, such as cyan (green blue) may be added to the color sections in the color filter, in addition to the three primary colors of light, i.e., red, green, and blue. An example is discussed in the following Patent Document 1.
Patent Document 1: JP2006-058332

### Problem to be Solved by the Invention

However, when an additional color included in the color sections in the color filter as described above in addition to the three primary colors of light, the problem may arise that the displayed image tends to have tone with the added color. The problem may be overcome by controlling the driving of the individual TFTs corresponding to the individual pixels of the liquid crystal panel and thereby the amount of light through the individual color sections, to correct the chromaticity of the displayed image. However, in this case, the amount of transmitted light tends to be decreased as a result of the chromaticity correction, possibly resulting in a decrease in brightness.

In view of the above problem, the present inventor came to the following conclusion after a series of researches. Namely, the inventor concluded that the chromaticity of the displayed image could be corrected without a decrease in brightness by adjusting the chromaticity of the light source included in the backlight unit irradiating the liquid crystal panel with light. Nevertheless, there is still room for consideration as to what color other than cyan could be added to the three primary colors in the liquid crystal panel of the multiple primary color type. And in the case, discussion of what light source is preferable for chromaticity adjustment is insufficient.

### DISCLOSURE OF THE PRESENT INVENTION

The present invention was made in view of the foregoing circumstances and an object of the present invention is to obtain excellent color reproducibility and high brightness.

### Means for Solving the Problem

A display device according to the present invention includes a display panel including a pair of substrates and a substance provided between the substrates. The substance has optical characteristics that vary with application of an electric field between substances. A lighting device includes an LED as a light source. The LED is configured to irradiate light toward the display panel. One of the substrates of the display panel includes a color filter including a plurality of blue, green, red, and yellow color sections. The LED includes an LED element as a light emitting source and phosphors configured to emit light when excited by the light from the LED element. The phosphors include at least two types of phosphors with different dominant emission wavelengths in a range of 480 nm to 580 nm.

Thus, the color filter is formed on one of the pair of substrates in the display panel, and the color filter includes the yellow color section in addition to color sections of the three primary colors of light, i.e., the blue, green, and red color sections. Thus, the color reproduction range that the human eye can perceive, i.e., the color gamut, can be expanded, and also the color reproducibility for the object color in the natural world can be increased, thereby improved display quality can be obtained. In addition, the light through the yellow color section of the color sections included in the color filter has a wavelength close to the peak of luminosity factor. Therefore, such light tends to be perceived by the human eye as being bright, i.e., as having high brightness, even when the amount of energy of the light is small. Thus, sufficient brightness can be obtained even when the output of the light sources is restrained, reducing the electric power consumption by the light sources thereby to achieve superior environmental friendliness. In other words, the resulting high brightness can be utilized for providing a sharp sense of contrast, leading to further improvement in display quality.

On the other hand, when the yellow color section is included in the color filter, the output light from the display panel, i.e., the display image, tends to have yellowishness as a whole. In order to avoid this, the chromaticity of the displayed image may be corrected by controlling the amount of transmitted light through the color sections. However, this chromatic correction method tends to decrease in the amount of transmitted light, possibly resulting in a decrease in brightness. The present inventor came to the conclusion, after a series of studies, that the chromaticity of the displayed image can be corrected without a decrease in brightness by adjusting the chromaticity of the light source used in the lighting device. Therefore, according to the present invention, the LED is used as the light source. The LED, compared to other light sources such as a cold cathode tube, can maintain relatively high brightness when the chromaticity is adjusted in accordance with the display panel with the yellow color section, for reasons such as good compatibility in spectral characteristics. Thus, the chromaticity of the displayed image can be appropriately corrected without a decrease in brightness.

Further researches by the present inventor on the configuration of the LED used in the light source specified the LED that satisfies both the brightness and color reproducibility requirements. Specifically, according to the present invention, the LED includes an LED element as a light emitting source and phosphors that emit light upon excitation by the light from the LED element. The phosphors include at least two types of phosphors with different dominant emission wavelengths in the range of 480 nm to 580 nm. Of the at least two types of phosphors, one with the dominant emission wavelength on a relatively longer wavelength side in the range of 480 nm to 580 nm has the dominant emission wavelength relatively close to the yellow wavelength region. Such phosphor is superior in brightness, but inferior in color reproducibility because the dominant emission wavelength is close to the wavelength of the transmitted light through the yellow color section of the color filter. On the other hand, of the at least two types of phosphors, one with the dominant emission wavelength on a relatively shorter wavelength side in the range of 480 nm to 580 nm has the dominant emission wavelength relatively far from the yellow wavelength region. Such phosphor is superior in color reproducibility, but inferior in brightness because of the different wavelength from that of the transmitted light through the yellow color section. Thus, the phosphors with single dominant emission wavelength in the range of 480 nm to 580 nm do not satisfy both the brightness and color reproducibility requirements. In this respect, according to the present invention, at least two types of phosphors with different dominant emission wavelengths in the range of 480 nm to 580 nm are used. Therefore, high brightness and excellent color reproducibility are both achieved.

Preferably, the embodiments of the present invention may include the following configurations.

(1) The at least two types of phosphors may have the dominant emission wavelengths in a range of 500 nm to 560 nm. In the at least two types of phosphors with the dominant emission wavelengths in the range of 480 nm to 580 nm, the dominant emission wavelength above 560 nm may be too close to the yellow wavelength region, i.e., the wavelength region of the transmitted light through the yellow color section in the color filter, possibly resulting in deterioration in color reproducibility. Conversely, the dominant emission wavelength below 500 nm may be too far from the yellow wavelength region, possibly resulting in a decrease in brightness. In this respect, according to the present invention, by selecting the dominant emission wavelengths of the at least two types of phosphors in the range of 500 nm to 560 nm, both high brightness and excellent color reproducibility can be achieved in a balanced manner.

(2) The at least two types of phosphors may include a phosphor with the dominant emission wavelength of 530 nm. By thus including the phosphor with the dominant emission wavelength of 530 nm, better color reproducibility can be obtained.

(3) The at least two types of phosphors may include a phosphor with the dominant emission wavelength of 540 nm. By thus including the phosphor with the dominant emission wavelength of 540 nm, higher brightness can be obtained.

(4) The at least two types of phosphors may include a first phosphor with the dominant emission wavelength of 530 nm and a second phosphor with the dominant emission wavelength of 540 nm. By thus including the phosphor with the dominant emission wavelength of 540 nm, higher brightness can be obtained; in addition, by including the phosphor with the dominant emission wavelength of 530 nm, better color reproducibility can be obtained. Accordingly, both high brightness and excellent color reproducibility can be achieved in a more preferable manner.

(5) The first and second phosphors may be contained in substantially equal amounts. In this way, both high brightness and excellent color reproducibility can be achieved in an extremely preferable manner.

(6) The at least two types of phosphors may include a first phosphor with the dominant emission wavelength on the relatively shorter wavelength side and relatively far from 555 nm, and a second phosphor with the dominant emission wavelength on the relatively longer wavelength side and relatively close to 555 nm. The second phosphor on the relatively longer wavelength side has the dominant emission wavelength relatively close to 555 nm, which is the peak wavelength of the luminosity factor, leading to high brightness. On the other hand, the first phosphor on the relatively shorter wavelength side has the dominant emission wavelength relatively far from 555 nm, leading to excellent color reproducibility. With such the first phosphor and the second phosphor, both high brightness and excellent color reproducibility can be preferably achieved.

(7) The first and second phosphors may be contained in substantially equal amounts. In this way, both high brightness and excellent color reproducibility can be achieved in an extremely preferable manner.

(8) The at least two types of phosphors may have a difference of 10 nm in the dominant emission wavelength. If the difference in the dominant emission wavelength between the at least two types of phosphors is less than 10 nm, differences in both brightness and wavelength between the phosphors become too small to satisfy the brightness and color reproducibility requirements. On the other hand, if the difference in dominant emission wavelength between the at least two types of phosphors is more than 10 nm, differences in the brightness and wavelength between the phosphors is too large to satisfy both the brightness and color reproducibility requirements. In this respect, according to the present invention, by setting the difference in dominant emission wavelength between the at least two types of phosphors at 10 nm, both high brightness and excellent color reproducibility can be achieved in a balanced manner.

(9) The at least two types of phosphors may include a SiAlON-based phosphor. In this way, because the SiAlON-based phosphor is a nitride containing at least four elements of Si, Al, O, and N, excellent emission efficiency and durability can be obtained compared to the case where a sulfide or oxide phosphor is used, for example. In addition, the light emitted by the SiAlON-based phosphor has higher color purity than the light from a YAG-based phosphor, for example. Thus, the chromaticity adjustment of the LED can be more easily performed.

(10) The SiAlON-based phosphor may be a β-SiAlON. In this way, better emission efficiency and durability can be obtained. In addition, the light emitted from the β-SiAlON has particularly high color purity. Thus, the chromaticity adjustment of the LED can be even more easily performed.

The β-SiAlON may use a rare-earth element (such as Eu, Tb, Yg, or Ag) as an activator and is expressed by the general formula Si₆₋ₓAl_{z}O_{z}N_{8-z} (z is the amount of solid solution) in which aluminum and oxygen are dissolved in β-type silicon nitride crystal.

(11) The β-SiAlON may use Eu as the activator. By thus using Eu (europium) from among the rare-earth elements as the activator, particularly high brightness can be obtained.

(12) The at least two types of phosphors may include a first phosphor with the dominant emission wavelength on the relatively shorter wavelength side and a second phosphor with the dominant emission wavelength on the relatively longer wavelength side. The first and second phosphors may be both the SiAlON-based phosphors. In this way, high brightness and excellent color reproducibility can be achieved in a balanced manner.

(13) The phosphors may further include at least one type of phosphor with the dominant emission wavelength in a range of 580 nm to 780 nm. By thus providing the at least one type of phosphor with the dominant emission wavelength in the range of 580 nm to 780 nm, in addition to the at least two types of phosphors with the dominant emission wavelengths in the range of 480 nm to 580 nm, better color reproducibility can be obtained.

(14) The at least one type of phosphor may have the dominant emission wavelength in a range of 600 nm to 780 nm. In this way, the dominant emission wavelength of the at least one type of phosphor lies in the red wavelength region, which is relatively far from the dominant emission wavelengths (480 nm to 580 nm) of the at least two types of phosphors. Thus, compared to the case where the dominant emission wavelength lies in the yellow wavelength region, even better color reproducibility can be obtained.

(15) The at least one type of phosphor may have the dominant emission wavelength in a range of 610 nm to 650 nm. In this way, even better color reproducibility can be obtained.

(16) The at least one type of phosphor may be a CASN-based phosphor. In this way, because the CASN-based phosphor is a nitride containing at least four elements of Ca, Al, Si, and N, superior emission efficiency can be obtained compared to the case where a sulfide or oxide phosphor is used, for example. The CASN-based phosphor may use the rare-earth element (such as Eu, Tb, Yg, or Ag) as the activator.

(17) The CASN-based phosphor may be a CASN (CaAlSiN₃:Eu). By thus using Eu (europium) from among the rare-earth elements as the activator, particularly high brightness can be obtained.

(18) The LED element may have the dominant emission wavelength in a range of 380 nm to 480 nm. In this case, in order to correct the chromaticity of the displayed image on the display panel including the color section of yellow in addition to the three primary colors of light, it is preferable to adjust the light from the LED to have bluishness. The blue is the complementary color to yellow. In this respect, in the LED according to the present invention, the LED element that emits light in the blue wavelength region (blue light) is used, to emit blue light with extremely high efficiency. Accordingly, when the chromaticity of the LED is adjusted toward blue, brightness is not easily decreased and high brightness can be maintained.

(19) The LED element may have the dominant emission wavelength in a range of 440 nm to 460 nm. In this way, even higher brightness can be obtained.

(20) The color filter may be configured such that each chromaticity of blue, green, red, and yellow output lights obtained by passing the light from the LED through the color sections in the color filter lies outside a common region of a NTSC chromaticity region according to a NTSC standard and a EBU chromaticity region according to a EBU standard in a CIE1976 chromaticity diagram. In this way, the common region is generally included in the chromaticity region of the output light. Therefore, sufficient color reproducibility can be ensured.

The “NTSC chromaticity region according to a NTSC standard” refers to a region within a triangle with the vertices at the three points in which the values of (u′, v′) are (0.0757, 0.5757), (0.1522, 0.1957), and (0.4769, 0.5285) in the CIE1976 chromaticity diagram. The “EBU chromaticity region according to an EBU standard” refers to a region within a triangle with the vertices at the three points in which with the values of (u′, v′) are (0.125, 0.5625), (0.1754, 0.1579), and (0.4507, 0.5229) in the CIE1976 chromaticity diagram. The “common region” refers to a region within a quadrangle with the vertexes at the four points in which the values of (u′, v′) are (0.125, 0.5625), (0.1686, 0.2125), (0.3801, 0.4293), and (0.4507, 0.5229) in the CIE1976 chromaticity diagram.

(21) The chromaticity region of the output light obtained by passing the light from the LED through the color sections in the color filter may occupy 70% or more of the NTSC chromaticity region according to the NTSC standard. In this way, sufficient color reproducibility in displaying an image can be ensured, leading to good display quality.

(22) The lighting device may include a chassis that houses the LED and an optical member. The chassis may include a bottom portion arranged on a side opposite to the light output side of the LED. The optical member may be arranged on the light output side in an opposed manner with respect to both the bottom portion and the LED. In this way, the light emitted from the LED is irradiated onto the optical member arranged on the light output side in an opposed manner with respect to the bottom portion and the LED, and the light is output toward the display panel through the optical member.

(23) The LED may include a diffuser lens on the light output side of the LED to diffuse the light from the LED. In this way, the light emitted from the LED is output while being diffused by the diffuser lens. Thus, unevenness in output light is not likely to occur. Therefore, the number of the LEDs installed can be decreased and cost reduction can be achieved.

(24) The lighting device may further include alight guide member with an end portion opposed to the LEDs. The light guide member may guide the light from the LED toward the display panel therethrough. Generally, a light guide member may have high transparency but often have yellowishness, although slightly. As a result, when the light emitted from the LED passes through the light guide member, the transmitted light also tends to slightly have yellowishness. In this case of thus including the light guide member with the yellowishness as well as the display panel with the yellow color section, by adjusting the chromaticity of the LED accordingly, the chromaticity of the displayed image can be appropriately corrected without a decrease in brightness.

(25) The light guide member may include an elongated light entrance surface on the end portion opposed to the LEDs. The LED may include a lens member that covers the light output side of the LED and diffuses light. The lens member may be opposed to the light entrance surface of the light guide member and curved along the longitudinal direction of the light entrance surface to be convex toward the light guide member. In this way, the light emitted by the LED is spread by the lens member in the longitudinal direction of the light entrance surface, resulting in reducing dark portions that could be formed at the light entrance surface of the light guide member. Thus, even when the distance between the LED and the light guide member is short and the number of the LEDs is small, light with uniform brightness can enter on over the entire light entrance surface of the light guide member.

(26) The lighting device may further include a reflection sheet between the LED and the light guide member along the longitudinal direction of the light entrance surface. In this way, the light scattered from the lens member toward the outside of the light guide member can be reflected by the reflection sheet to enter on the light guide member. Thus, the entrance efficiency of the light from the LED on the light guide member can be increased.

(27) The display panel may be a liquid crystal panel including liquid crystal as the substance, the optical characteristics of which vary with application of an electric field. In this way, the display panel can be used for various purposes, such as for television or personal computer displays, particularly for large screens.

In order to solve the problem, a television receiver according to the present invention includes the display device and a reception unit configured to receive a television signal.

According to the television receiver, the display device that displays a television image on the basis of the television signal is configured to appropriately correct the chromaticity of the display image while high brightness is obtained. Therefore, excellent display quality of the television image can be obtained.

In addition, the television receiver may further include an image conversion circuit converting a television image signal output from the reception unit into an image signal for the respective colors of red, green, blue, or yellow. Thus, the television image signal is converted by the image conversion circuit into the image signal for respective colors corresponding to the respective color sections R, G, B, and Y of the red, green, blue, and yellow included in the color filter. Therefore, the television image can be displayed with high display quality.

### Advantageous Effect of the Invention

According to the present invention, both high brightness and excellent color reproducibility can be obtained.

### BRIEF DESCRIPTION OF THE DRAWINGS

FIG. 1 is a an exploded perspective view illustrating a schematic configuration of a television receiver according to the first embodiment of the present invention;

FIG. 2 is an exploded perspective view showing a schematic configuration of a liquid crystal display device included in the television receiver;

FIG. 3 is a cross sectional view showing a cross sectional configuration of a liquid crystal panel along a long side direction thereof;

FIG. 4 is an enlarged plan view illustrating a planar configuration of an array substrate;

FIG. 5 is an enlarged plan view illustrating a planar configuration of a CF substrate;

FIG. 6 is a plan view showing an arrangement configuration of diffuser lenses, LED boards, first reflection sheets and holding members in a chassis of a backlight unit;

FIG. 7 is a cross sectional view of the liquid crystal display device taken along line vii-vii of FIG. 6;

FIG. 8 is a cross sectional view of the liquid crystal display device taken along line viii-viii of FIG. 6;

FIG. 9 is a plan view showing a detailed arrangement configuration of the diffuser lenses, the LED boards, and the holding members;

FIG. 10 is a cross sectional view taken along line x-x of FIG. 9;

FIG. 11 is a cross sectional view taken along line xi-xi of FIG. 9;

FIG. 12 is a CIE1931 chromaticity diagram showing the relationship between chromaticity and brightness of a cold cathode tube;

FIG. 13 is a CIE1931 chromaticity diagram illustrating the relationship between chromaticity and brightness of the LED;

FIG. 14 is a CIE1976 chromaticity diagram showing the chromaticity coordinates of Tables 2 to 4;

FIG. 15 is a graph showing light emission spectra of the LEDs in fifth to seventh comparative examples according to a first experimental example, and transmission spectra of the color sections in a liquid crystal panel of the three-primary color type;

FIG. 16 is a graph showing light emission spectra of the LEDs in eighth and ninth comparative examples and an exemplary example according to a second experimental example, and transmission spectra of the color sections in a liquid crystal panel of the four-primary color type;

FIG. 17 is an exploded perspective view of a liquid crystal display device according to a second embodiment of the present invention;

FIG. 18 is a cross sectional view showing a cross sectional configuration of the liquid crystal display device along a short side direction thereof;

FIG. 19 is a cross sectional view showing a cross sectional configuration of the liquid crystal display device along a long side direction thereof;

FIG. 20 is an enlarged perspective view of an LED board;

FIG. 21 is an exploded perspective view of a liquid crystal display device according to the third embodiment of the present invention;

FIG. 22 is a horizontal cross sectional view of the liquid crystal display device;

FIG. 23 is an enlarged plan view showing a planar configuration of a CF substrate according to an another embodiment (1) of the present invention; and

FIG. 24 is an enlarged plan view showing a planar configuration of a CF substrate according to another embodiment (2) of the present invention.

### BEST MODE FOR CARRYING OUT THE INVENTION

### First Embodiment

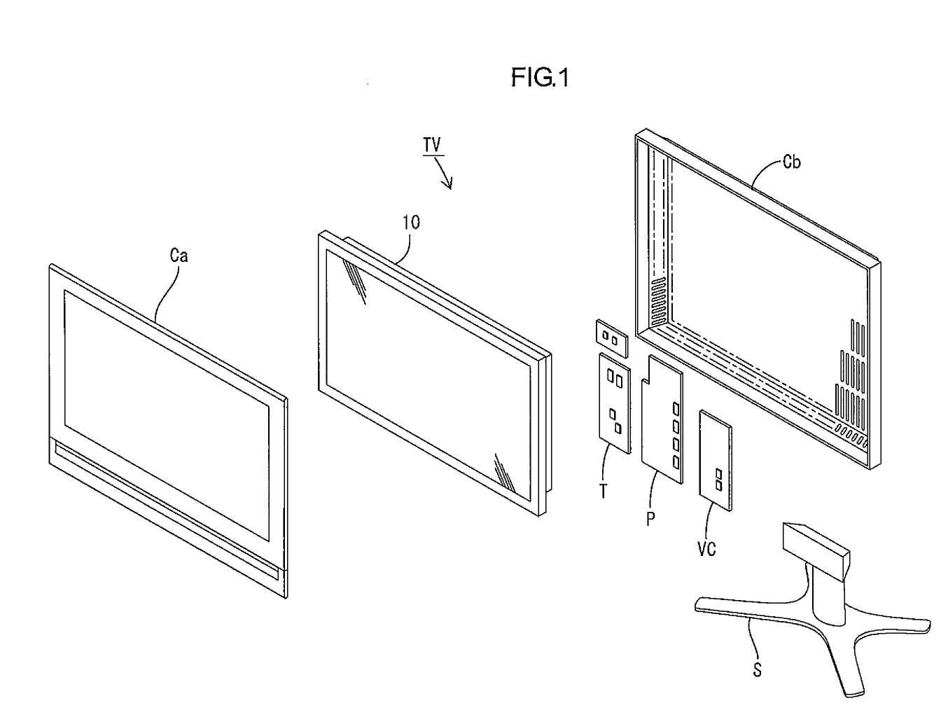

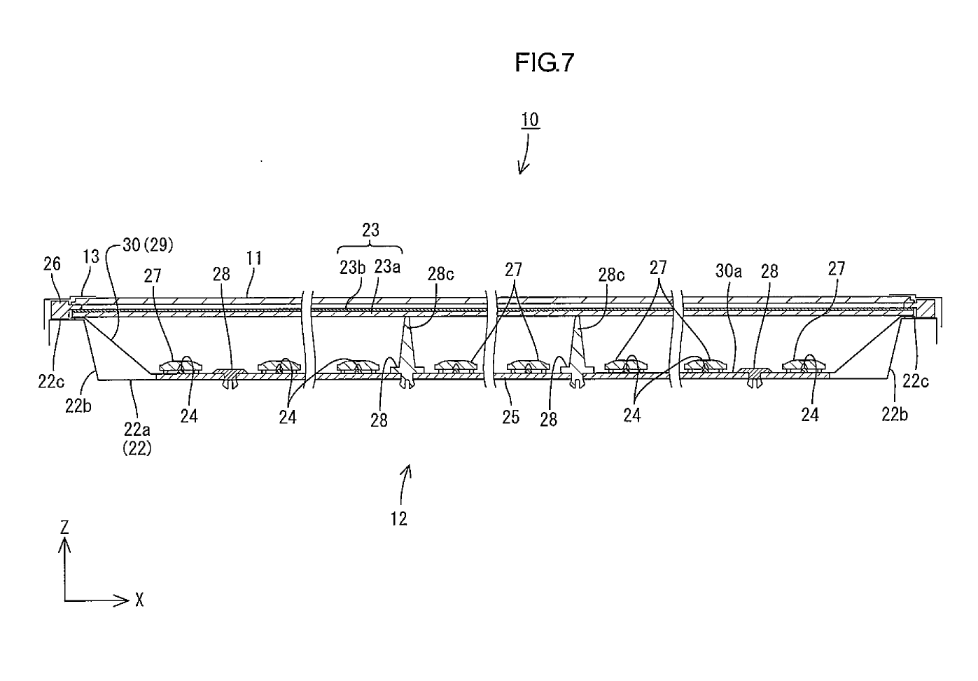

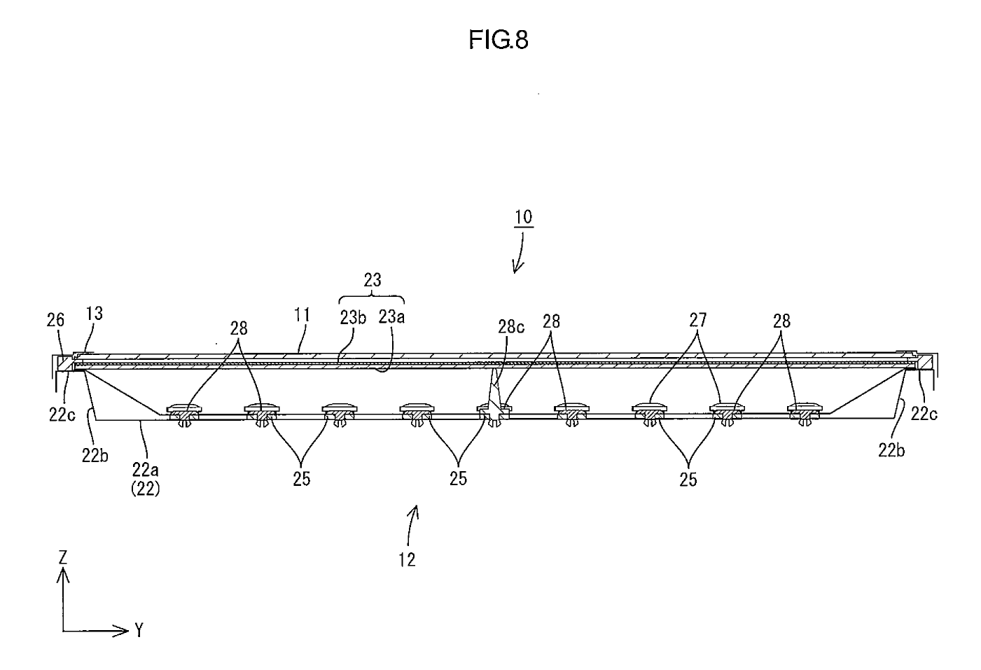

A first embodiment of the present invention will be described with reference to FIGS. 1 to 16. According to the present embodiment, a liquid crystal display device 10 will be described by way of example. In some parts of the drawings, an X-axis, a Y-axis, and a Z-axis are shown as the respective axial directions corresponding to the directions shown in the respective drawings. The upper side and the lower side shown in FIGS. 7 and 8 correspond to the front side and the rear side, respectively.

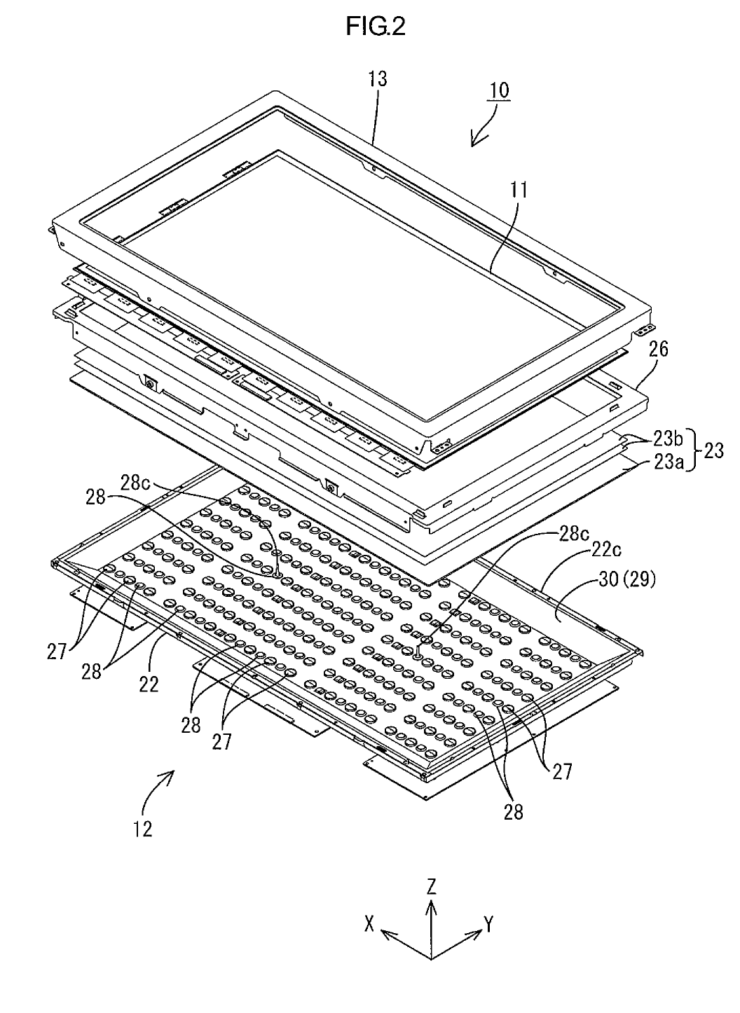

A television receiver TV according to the present embodiment, as shown in FIG. 1, includes the liquid crystal display device 10; front and rear cabinets Ca and Cb housing the liquid crystal display device 10 in a sandwiching manner; a power supply circuit board P supplying electric power; a tuner (reception unit) T configured to receive a television image signal; an image conversion circuit board VC converting the television image signal output from the tuner T into an image signal for the liquid crystal display device 10; and a stand S. The liquid crystal display device (display device) 10 as a whole has a horizontally long (elongated) square shape (rectangular shape). The liquid crystal display device 10 is housed with its long side direction and short side direction substantially aligned with the horizontal direction (X-axis direction) and the vertical direction (Y-axis direction; perpendicular direction), respectively. The liquid crystal display device 10, as shown in FIG. 2, includes a liquid crystal panel 11 as a display panel and a backlight unit (lighting device) 12 as an external light source, which are integrally held by a frame-shaped bezel 13 or the like.

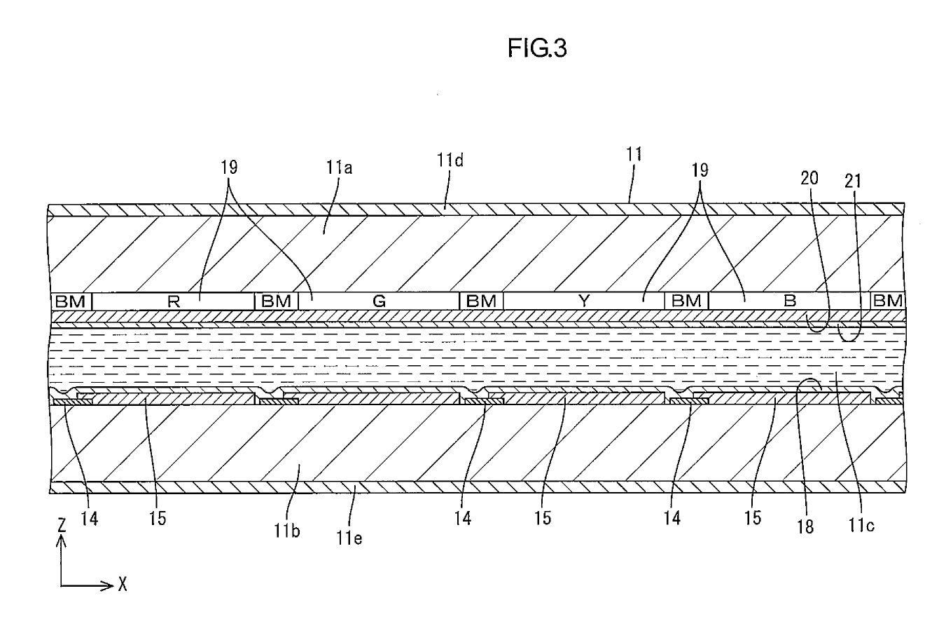

A configuration of the liquid crystal panel 11 of the liquid crystal display device 10 will be described in detail. The liquid crystal panel 11 as a whole has a horizontally long (elongated) square shape (rectangular shape). As shown in FIG. 3, the liquid crystal panel 11 includes a pair of transparent (light transmissive) glass substrates 11a and 11b, and a liquid crystal layer 11c between the substrates 11a and 11b. The liquid crystal layer 11c includes liquid crystal. The liquid crystal is a substance whose optical characteristics vary by application of an electric field. The substrates 11a and 11b are affixed to each other with a sealing agent, which is not shown, with a gap corresponding to the thickness of liquid crystal layer 11c maintained between the substrates. To the outer surfaces of the substrates 11a and 11b, polarizing plates 11d and 11e, respectively, are affixed. The liquid crystal panel 11 has a long side direction and a short side direction aligned with the X-axis direction and the Y-axis direction, respectively.

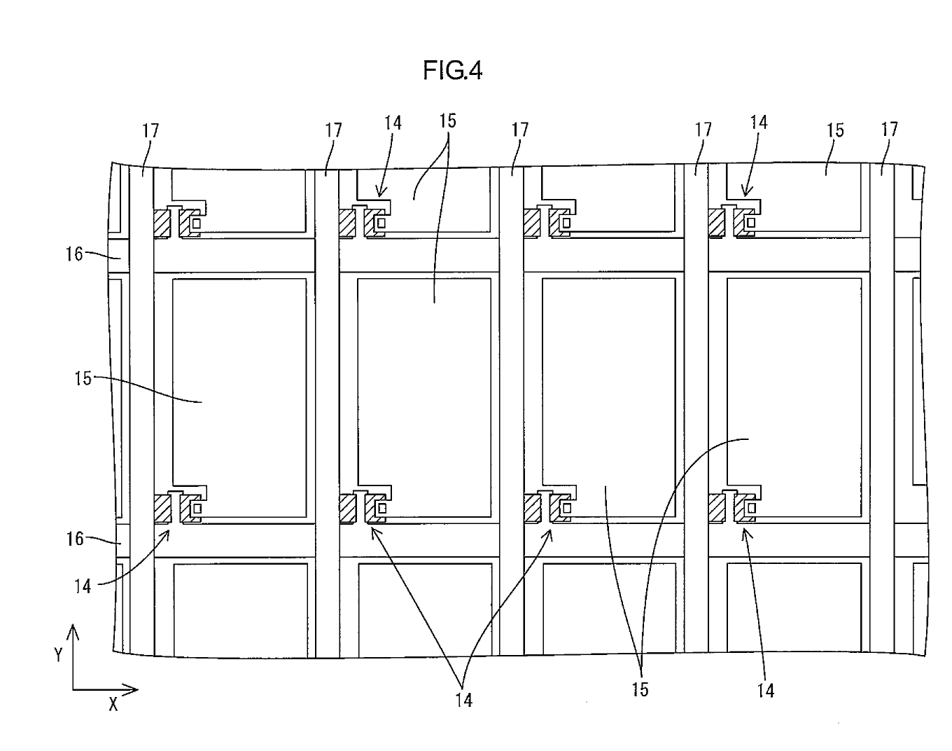

The front side (front surface side) one of the substrates 11a and 11b is a CF substrate 11a, and the rear side (back surface side) one of the substrates 11a and 11b is an array substrate 11b. On an inner surface of the array substrate 11b, i.e., the surface facing the liquid crystal layer 11c (or opposed to the CF substrate 11a), as shown in FIG. 4, a number of TFTs (Thin Film Transistors) 14 and pixel electrodes 15 as switching elements are arranged side by side in a matrix. Around the TFTs 14 and the pixel electrodes 15, gate wires 16 and source wires 17 are arranged in a lattice shape. The pixel electrodes 15 have a vertically long (elongated) square shape (rectangular shape) with a long side direction and a short side direction aligned with the Y-axis direction and the X-axis direction, respectively. The pixel electrodes 15 may be transparent electrodes of ITO (Indium Tin Oxide) or ZnO (Zinc Oxide). The gate wires 16 and the source wires 17 are connected to the gate electrodes and the source electrodes of the TFTs 14, respectively. The pixel electrodes 15 are connected to the drain electrodes of the TFTs 14. On the side of the TFTs 14 and the pixel electrodes 15 facing the liquid crystal layer 11c, an alignment film 18 aligning the liquid crystal molecules is arranged. At the ends of the array substrate 11b, terminal portions drawn out from the gate wires 16 and the source wires 17 are formed. To the terminal portions, a driver IC, which is not shown, driving the liquid crystal is crimped via an anisotropic conductive film (ACF). The liquid crystal driving driver IC is electrically connected to a display control circuit board, which is not shown, via various wiring substrates and the like. The display control circuit board is connected to the image conversion circuit board VC of the television receiver TV to supply a drive signal via the driver IC to the wires 16 and 17 on the basis of an output signal from the image conversion circuit board VC.

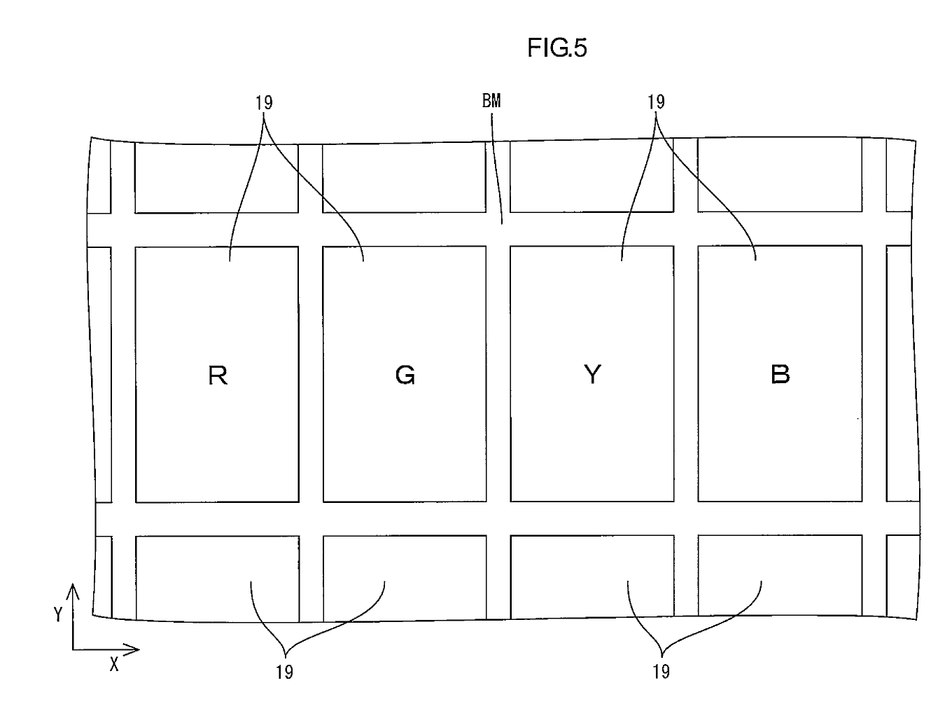

On the inner surface of the CF substrate 11a, i.e., on the surface facing the liquid crystal layer 11c (or opposed to the array substrate 11b), as shown in FIGS. 3 and 5, a color filter 19 including a plurality of each of color sections R, G, B, or Y arranged in a matrix corresponding to the respective pixels on the array substrate 11b is arranged. According to the present embodiment, the color filter 19 includes a yellow color section Y in addition to the red color section R, the green color section G, and the blue color section B as the three primary colors of light. The respective color sections R, G, B, and Y selectively transmit light of the respective corresponding colors (respective wavelengths). The color filter 19 is an arranged along the x-axis direction, the red color section R, the green color section G, the yellow color section Y, and the blue color section B in the order from the left side as shown in FIG. 5. The color sections R, G, B, and Y have a vertically long (elongated) square shape (rectangular shape) similar to the pixel electrodes 15, with a long side direction aligned with the Y-axis direction and a short side direction aligned with the X-axis direction. All the color sections have the same area. Between the color sections R, G, B, and Y, a lattice-shaped light blocking layer (black matrix) BM is provided for preventing the mixing of colors. On the side of the color filter 19 on the CF substrate 11a facing the liquid crystal layer 11c, a counter electrode 20 and an alignment film 21 are layered in order.

Thus, according to the present embodiment, the liquid crystal display device 10 has the liquid crystal panel 11 with the color filter 19 including the four color sections R, G, B, and Y. For this reason, the television receiver TV includes the dedicated image conversion circuit board VC. The image conversion circuit board VC is configured to convert the television image signal output from the tuner T into an image signal for the respective colors of blue, green, red, or yellow to output the image signal generated for the respective colors to the display control circuit board. On the basis of the image signals, the display control circuit board drives the TFTs 14 corresponding to the pixel of the respective colors on the liquid crystal panel 11 to appropriately control the amount of light transmitted through the color section R, G, B, or Y for the respective colors.

Next, a configuration of the backlight unit 12 will be described. The backlight unit 12, as shown in FIG. 2, includes a substantially box-shaped chassis 22 with an opening on the light output surface side (toward the liquid crystal panel 11); a group of optical members 23 covering the opening of the chassis 22; and a frame 26 arranged along the outer edges of the chassis 22 and holding the outer edges of the group of optical members 23 in a sandwiched manner with the chassis 22. The chassis 22 houses LEDs 24 arranged immediately under the optical members 23 (the liquid crystal panel 11) in an opposed manner; LED boards 25 on which the LEDs 24 are mounted; and diffuser lenses 27 attached to the LED boards 25 at positions corresponding to the LEDs 24. The chassis 22 also houses holding members 28 configured to hold the LED boards 25 between with the chassis 22; and a reflection sheet 29 reflecting the light within the chassis 22 toward the optical members 23. In the following, the constituent components of the backlight unit 12 will be described in detail.

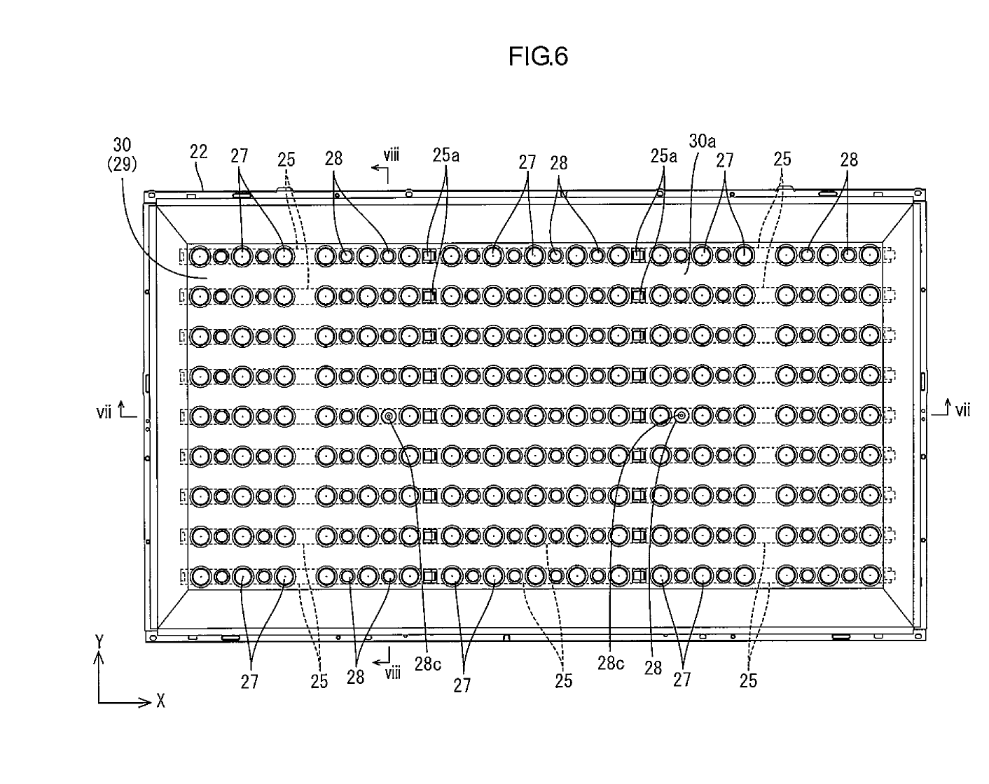

The chassis 22 is made of metal and, as shown in FIGS. 6 to 8, includes a bottom plate 22a with a horizontally long square shape (rectangular shape; oblong shape) similar to the liquid crystal panel 11; side plates 22b rising from the outer ends of the bottom plate 22a along the sides thereof (a pair of long sides and a pair of short sides) toward the front side (light output side); and backing plates 22c extending outward from the rising ends of the side plates 22b. Thus, the chassis 22 as a whole has a shallow box-like shape (substantially shallow dish-like shape) with an opening on the front side. The chassis 22 has a long side direction aligned with the X-axis direction (the horizontal direction) and a short side direction aligned with the Y-axis direction (the vertical direction). The backing plates 22c of the chassis 22 are configured to receive the frame 26 and the optical members 23 from the front side, as will be described later. The frame 26 is threadably mounted on the backing plates 22c. The bottom plate 22a of the chassis 22 has attaching holes 22d attaching the holding members 28. Specifically, a plurality of attaching holes 22d is arranged in a distributed manner at positions corresponding to the positions at which the holding members 28 are attached on the bottom plate 22a.

The optical members 23, as shown in FIG. 2, have a horizontally long square shape in plan view similar to the liquid crystal panel 11 and the chassis 22. The optical members 23, as shown in FIGS. 7 and 8, are arranged between the liquid crystal panel 11 and the LEDs 24 (LED boards 25) with the outer edges thereof placed on the backing plates 22c, to cover the opening of the chassis 22. The optical members 23 include the diffuser plate 23a on the rear side (facing the LEDs 24; opposite to the light output side), and the optical sheets 23b on the front side (facing the liquid crystal panel 11; the light output side). The diffuser plate 23a includes a substantially transparent plate-like base substrate of a resin with a predetermined thickness, in which a number of diffusing particles are dispersed. The diffuser plate 23a has the function of diffusing transmitted light. The optical sheets 23b are formed of a stack of three sheets each with a thickness smaller than the one of the diffuser plate 23a. Specific types of the optical sheets 23b may include a diffuser sheet, a lens sheet, and a reflection type polarizing sheet, from which one or more may be appropriately selected and used.

The frame 26, as shown in FIG. 2, has a frame-like shape extending along the outer peripheral edges of the liquid crystal panel 11 and the optical members 23. The frame 26 is configured to sandwich the outer edges of the optical members 23 (FIGS. 7 and 8) with the backing plates 22c. The frame 26 is also configured to receive the outer edges of the liquid crystal panel 11 on the rear side to sandwich the outer edges of the liquid crystal panel 11 with the bezel 13 on the front side (FIGS. 7 and 8).

Next, the LEDs 24 and the LED boards 25 will be described. The LEDs 24 are mounted on LED boards 25 and the surface on the opposite side to the mounting surface on which the LEDs 25 are mounted constitutes the light emitting surface as shown in FIGS. 6 to 8, which is of the top type. The LEDs 24 include a board portion which is fixedly attached on the LED boards 25. On the board portion, LED chips of an InGaN based material, for example, are sealed on with a resin material. The LED chips mounted on the board portion have a dominant emission wavelength in the range of 380 nm to 480 nm. The dominant emission wavelength of the LED chips is preferably in a range of 435 nm to 480 nm, i.e., a blue wavelength region, and more preferably in the range of 440 nm to 460 nm. Specifically, according to the present embodiment, the dominant emission wavelength of the LED chips is 451 nm, for example, to emit blue light with excellent color purity. The wavelength region of 380 nm to 480 nm includes the blue wavelength region (435 nm to 480 nm) and a violet wavelength region (380 nm to 435 nm).

The resin material with which the LED chips are sealed contains the green phosphor that emits green light upon excitation by the blue light emitted by the LED chips, and the red phosphor that emits red light upon excitation by the blue light emitted by the LED chips, the green phosphor and the red phosphor being dispersed at a predetermined ratio. On the basis of the blue light (light of blue component) emitted by the LED chips, the green light (light of green component) emitted from the green phosphor, and the red light (light of red component) emitted from the red phosphor, the LEDs 24 as a whole can emit light of a predetermined color, such as white or bluish white. By combining the light of green component from the green phosphor and the light of red component from the red phosphor, yellow light can be obtained. Thus, it can be said that the LEDs 24 have the light of yellow component in addition to the light of blue component from the LED chips. The chromaticity of the LEDs 24 may vary depending on the absolute or relative values of the contained amounts of the green phosphor and red phosphor. Thus, by appropriately adjusting the contained amounts of the green phosphor and the red phosphor, the chromaticity of the LEDs 24 can be adjusted. The green phosphor and the red phosphor of the LEDs 24 will be described in detail.

The LED boards 25, as shown in FIGS. 6 and 7, include base members with a horizontally long square shape in plan view. The LED boards 25 are housed in the chassis 22 along the bottom plate 22a with a long side direction aligned with the X-axis direction and a short side direction aligned with the Y-axis direction. On the front side of the plate surfaces of the base members of the LED boards 25 (i.e., facing the optical members 23), the LEDs 24 are surface-mounted. The light emitting surfaces of the LEDs 24 are opposed to the optical members 23 (the liquid crystal panel 11) with an optical axis LA aligned with the Z-axis direction, which is orthogonal to the display surface of the liquid crystal panel 11. Specifically, a plurality of LEDs 24 is arranged linearly side by side along the long side direction (X-axis direction) of the LED boards 25, and connected in series by a wiring pattern formed on the LED boards 25. The LEDs 24 have a substantially constant arrangement pitch; namely, the LEDs 24 are arranged at regular intervals. At the respective ends of the LED boards 25 in the long side direction, connector portion 25a is provided.

As shown in FIG. 6, a plurality of the LED boards 25 with the above configuration is arranged side by side in the X-axis direction and the Y-axis direction in the chassis 22, with their long side directions and short side directions aligned with each other. Namely, the LED boards 25 and the LEDs 24 mounted thereon are arranged in rows and columns (in a matrix or planar arrangement) in the chassis 22, the row direction corresponding to the X-axis direction (the long side direction of the chassis 22 and the LED boards 25) and the column direction corresponding to the Y-axis direction (the short side direction of the chassis 22 and the LED boards 25). Specifically, a total of 27 LED boards 25, i.e., three in the X-axis direction times nine in the Y-axis direction, are arranged side by side in the chassis 22. The LED boards 25 arranged along the X-axis direction to form a row are mutually electrically connected by the adjacent connector portions 25a fitted to each other. The connector portions 25a corresponding to the ends of the chassis 22 in the X-axis direction are electrically connected to an external control circuit, which is not shown. Thus, all of the LEDs 24 arranged on the LED boards 25 constituting a single row are connected in series to be turned on or off altogether by a single control circuit, thus achieving cost reduction. The LED boards 25 arranged along the Y-axis direction have substantially the same arrangement pitch. Thus, in the chassis 22, the LEDs 24 are arranged in a planar manner along the bottom plate 22a at substantially regular intervals with respect to the X-axis direction and the Y-axis direction.

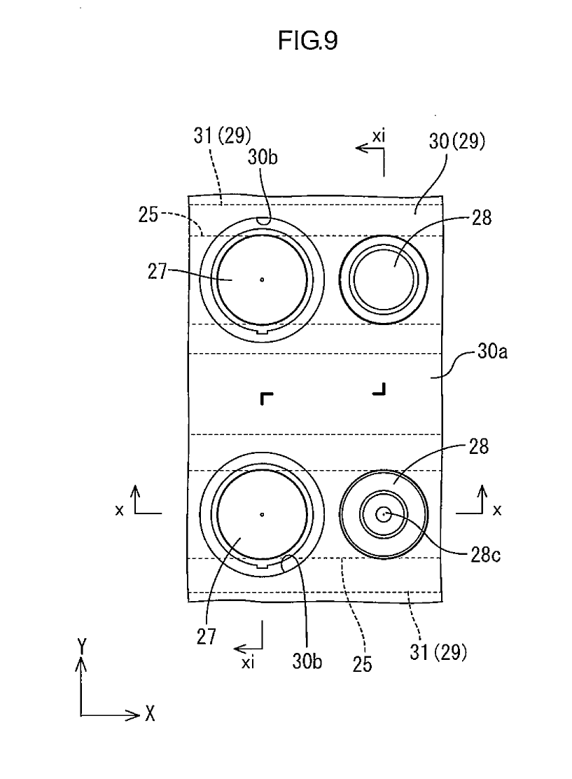

The diffuser lenses 27 are made of a substantially transparent (highly light transmissive) synthetic resin material with a refractive index higher than that of air (such as polycarbonate or acrylic material). The diffuser lenses 27 have a predetermined thickness and a substantially circular shape in plan view, as shown in FIGS. 9 to 11. The diffuser lenses 27 are attached to the LED boards 25 to cover the LEDs 24 individually from the front side, that is, the diffuser lenses 27 overlap with the LEDs 24 in plan view. The diffuser lenses 27 are configured to output the light emitted by the LEDs 24, which has strong directionality, in a diffusing manner. Specifically, the light emitted by the LEDs 24 passes through the diffuser lenses 27 to reduce its directionality. Therefore, the regions between the adjacent LEDs 24 can be prevented from being visually recognized as being dark even when the intervals between the LEDs 24 are increased. Thus, the number of LEDs 24 installed can be decreased. The diffuser lenses 27 are substantially coaxial with the LEDs 24 in plan view.

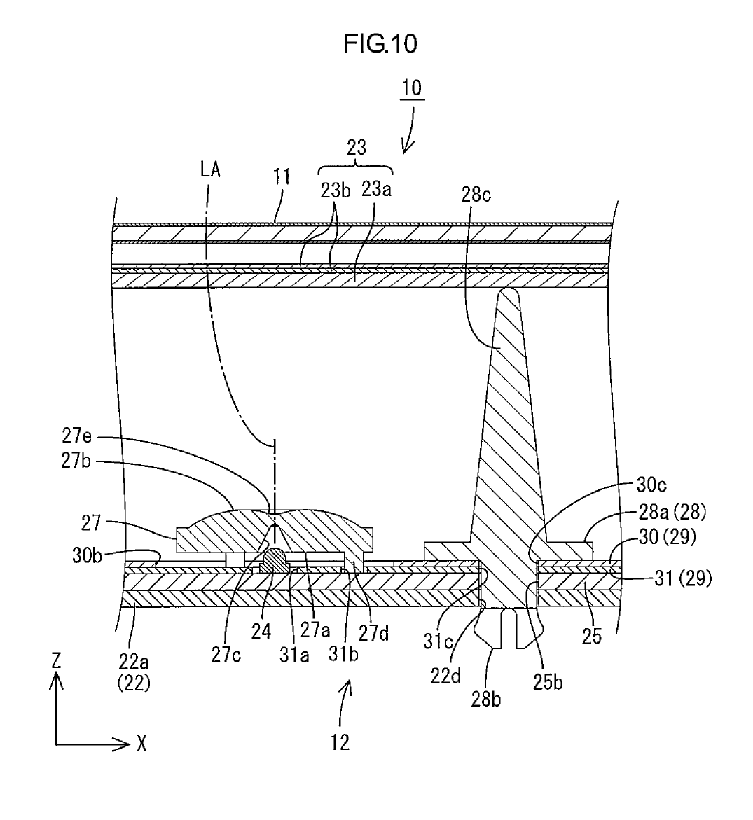

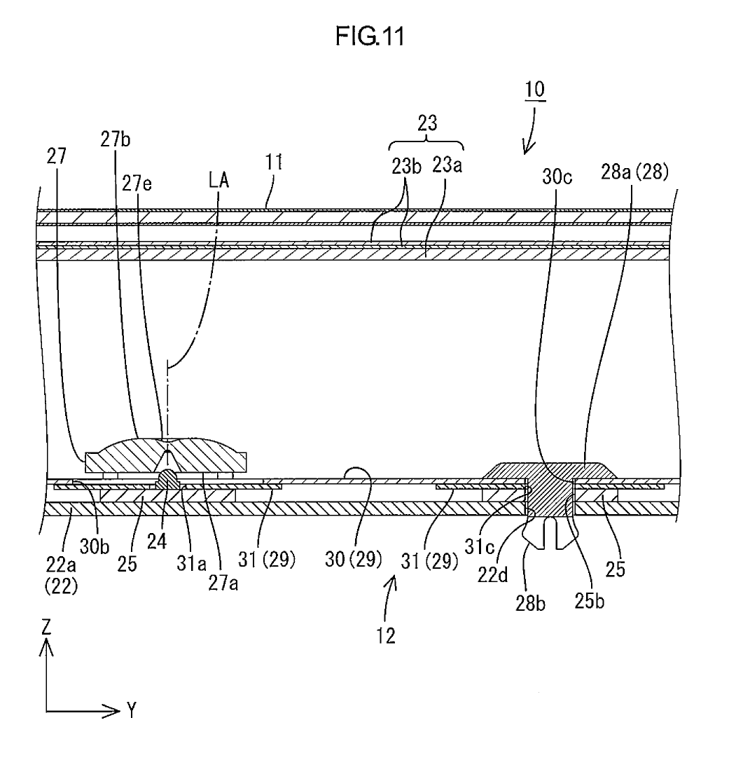

The diffuser lenses 27 include a light entrance surface 27a on the rear side facing the LED boards 25 (LEDs 24), through which the light from the LEDs 24 enters. The diffuser lenses 27 further include a light output surface 27b on the front side facing the optical members 23, from which the light is output. The light entrance surface 27a, as shown in FIGS. 10 and 11, as a whole is parallel to the plate surface of the LED boards 25 (in the X-axis direction and the Y-axis direction). The light entrance surface 27a includes a light-entrance-side concave portion 27c in a region overlapping with the LEDs 24 in plan view to form inclined surfaces with respect to the optical axis LA of the LEDs 24. The light-entrance-side concave portion 27c has a substantially conical shape (with an inverted-V cross section) and is substantially coaxial with the diffuser lenses 27. The light emitted by the LEDs 24 enters the light-entrance-side concave portion 27c and is refracted at large angles by the inclined surfaces to enter on the diffuser lenses 27. The light entrance surface 27a also includes an attaching leg portion 27d protruding therefrom, providing an attaching structure with respect to the LED boards 25. The light output surface 27b has a gently curved, substantially spherical shape to output the light from the diffuser lenses 27 while being refracted at large angles. In the overlapping region of the light output surface 27b with the LEDs 24 in plan view, a light-output-side concave portion 27e of mortar shape is formed. The light-output-side concave portion 27e may be configured to output the light from the LEDs 24 while most of the light is refracted at wide angles, or to reflect some of the light from the LEDs 24 toward the LED boards 25.

Next, the holding members 28 will be described. The holding members 28 are made of a synthetic resin, such as polycarbonate resin, and have a white surface for excellent light reflectivity. The holding member 28, as shown in FIGS. 9 to 11, includes a main body portion 28a extending along the plate surface of the LED boards 25, and a fixing portion 28b protruding from the main body portion 28a toward the rear side, i.e., the chassis 22, to be fixed to the chassis 22. The main body portion 28a has a substantially circular plate-like shape in plan view and sandwiches the LED boards 25 and the reflection sheet 29, which will be described in detail later, with the bottom plate 22a of the chassis 22. The fixing portion 28b penetrates through insertion holes 25b and the attaching holes 22d, which are respectively formed in the LED boards 25 and the bottom plate 22a of the chassis 22 at positions corresponding to the attaching positions of the holding members 28, to be locked on the bottom plate 22a. As shown in FIG. 6, a number of the holding members 28 are arranged side by side in rows and columns on the plane of the LED boards 25. Specifically, the holding members 28 are arranged between the adjacent diffuser lenses 27 (LEDs 24) with respect to the X-axis direction.

Of the holding members 28, a pair arranged at the center of the screen include, as shown in FIGS. 2 and 6 to 8, a support portion 28c protruding from the main body portion 28a toward the front side. The support portion 28c is configured to support the optical members 23 from the rear side to maintain a constant positional relationship between the LEDs 24 and the optical members 23 in the Z-axis direction and thereby to prevent unexpected deformation of the optical members 23.

Next, the reflection sheet 29 will be described. The reflection sheet 29 includes a first reflection sheet 30 sized to cover substantially the entire area of the inner surface of the chassis 22, and second reflection sheets 31 sized to cover the LED boards 25 individually. The reflection sheets 30 and 31 are made of a synthetic resin and have a white surface for excellent light reflectivity. The reflection sheets 30 and 31 extend along the bottom plate 22a (LED boards 25) in the chassis 22.

The first reflection sheet 30 will be described. As shown in FIG. 6, most area of the first reflection sheet 30 at the central along the bottom plate 22a of the chassis 22 constitutes a bottom portion 30a. The bottom portion 30a has lens insertion holes 30b into which the LEDs 24 arranged in the chassis 22 and the diffuser lenses 27 covering the LEDs 24 can be inserted. A plurality of the lens insertion holes 30b is provided side by side in the bottom portion 30a at positions overlapping with the LEDs 24 and the diffuser lenses 27 in plan view, i.e., in a matrix arrangement. The lens insertion holes 30b, as shown in FIG. 9, have a circular shape in plan view with a diameter greater than the diffuser lenses 27. The bottom portion 30a also includes insertion holes 30c for the fixing portions 28b at corresponding positions thereto to be adjacent to the lens insertion holes 30b of the holding members 28. The first reflection sheet 30, as shown in FIG. 6, covers the regions between the adjacent diffuser lenses 27 and their outer peripheral regions in the chassis 22 to reflect the light traveling toward those regions toward the optical members 23. Further, as shown in FIGS. 7 and 8, the first reflection sheet 30 has the outer peripheral side portions, which rise and extend to cover the side plates 22b and the backing plates 22c of the chassis 22. The chassis 22 and the optical members 23 sandwich the ends of the outer peripheral side portions between. The portions of the first reflection sheet 30 connecting the bottom portion 30a and the portions placed on the backing plates 22c are inclined.

On the other hand, the second reflection sheets 31, as shown in FIG. 9, have a rectangular shape in plan view substantially similar to the LED boards 25. As shown in FIGS. 10 and 11, the second reflection sheets 31 are laid over the front side surface of the LED boards 25 to be opposed to the diffuser lenses 27. Namely, the second reflection sheets 31 are interposed between the diffuser lenses 27 and the LED boards 25. Thus, the light returned from the diffuser lenses 27 toward the LED boards 25 or the light entering the space between the diffuser lenses 27 and the LED boards 25 from the space outside the diffuser lenses 27 in plan view can be reflected by the second reflection sheets 31 back toward the diffuser lenses 27. In this way, the light use efficiency can be increased and thereby increased brightness can be obtained. In other words, sufficient brightness can be obtained even when the number of LEDs 24 installed is decreased for cost reduction.

The second reflection sheets 31 have a horizontally long square shape in plan view, similar to the associated LED boards 25, to cover the entire areas of the LED boards 25 from the front side. The second reflection sheets 31, as shown in FIGS. 9 and 11, have a short side dimension greater than the LED boards 25 and even greater than the diameters of the diffuser lenses 27 and the lens insertion holes 30b of the first reflection sheet 30. Thus, the edges of the lens insertion holes 30b of the first reflection sheet 30 overlap with the second reflection sheets 31 on the front side. Accordingly, in the chassis 22, the first reflection sheet 30 and the second reflection sheets 31 are continuously arranged without gaps in plan view, such that the chassis 22 or the LED boards 25 is hardly exposed onto the front side through the lens insertion holes 30b. As a result, the light within the chassis 22 is efficiently reflected toward the optical members 23, which contributes greatly to the improvement in brightness. The second reflection sheets 31 include LED insertion holes 31a for the LEDs 24, leg portion insertion holes 31b for the attaching leg portions 27d of the diffuser lenses 27, and insertion holes 31c for the fixing portions 28b of the holding members 28, respectively at overlapping positions in plan view.

As described above, according to the present embodiment, the color filter 19 of the liquid crystal panel 11, as shown in FIGS. 3 and 5, includes the yellow color section Y in addition to the color sections R, G, and B of the three primary colors of light. Thus, the color gamut of the display image displayed by the transmitted light is expanded. Therefore, the image can be displayed with excellent color reproducibility. Further, the light transmitted through the yellow color section Y has wavelength close to the peak of luminosity factor, and therefore, tends to be perceived by the human eye as being bright even at small energy level. Thus, sufficient brightness can be obtained even when the output from the light sources (LEDs 24) of the backlight unit 12 is restrained. Accordingly, the electric power consumption by the light sources can be decreased and thereby improved environmental friendliness can be obtained.

On the other hand, when the primary four-color liquid crystal panel 11 is used, the display image of the liquid crystal panel 11 may tend to become yellowish as a whole. This problem may be overcome by controlling the driving of the TFTs 14 for the color sections R, G, B, and Y individually and thereby adjusting the amount of transmitted light through the color sections R, G, B, and Y to correct the chromaticity of the displayed image. However, in this case, the overall amount of transmitted light tends to be decreased as a result of chromaticity correction and thereby a decrease in brightness may be caused. In view of this problem, the present inventor devised the technique for correcting the chromaticity of the displayed image without a decrease in brightness by adjusting the chromaticity of the light source of the backlight unit 12. The light source of the backlight unit 12 may include two types, i.e., an LED and a cold cathode tube. Thus, a first comparative experiment is to determine what brightness can be obtained for these two types of light sources subjected to chromaticity adjustment in association with the liquid crystal panel of the four primary color type. The results are shown in Table 1 below.

<First Comparative Experiment>

The first comparative experiment involves a first comparative example in which a liquid crystal panel of the three primary color type with the color sections R, G, and B of the three primary colors of light is used in combination with a cold cathode tube as the light source; a second comparative example in which a liquid crystal panel of the four primary color type with the color sections R, G, B, and Y of the four colors is used in combination with a cold cathode with chromaticity adjustment in accordance with the liquid crystal panel; a third comparative example in which a liquid crystal panel of the three primary color type similar to the above first comparative example is used in combination with an LED as the light source; and a fourth comparative example in which a liquid crystal panel of the four primary color type similar to the above second comparative example is used in combination with an LED subjected to chromaticity adjustment in accordance with the liquid crystal panel. Table 1 shows the results of measuring, in each of the comparative examples: the brightness of the light source; chromaticity of the light source; brightness of output light (displayed image) from the liquid crystal panel; and chromaticity of output light from the liquid crystal panel at the time of white display. The cold cathode tube (not shown) used in the first and the second comparative examples is a type of discharge tube, with configuration of a thin glass tube in which a light-emitting substance, such as mercury, is enclosed, the inner wall surfaces is coated with a fluorescent material, and each one electrode portion is enclosed in both ends of the glass tube. The LEDs used in the third and the fourth comparative examples include LED chips emitting blue light as light emitting sources, green phosphors emitting green light, and red phosphors emitting red light. The brightness ratio and chromaticity of the light sources and the output light are determined by measuring the light passed through the color sections R, G, B, and Y in the color filter 19 by using a spectrophotometer, for example. Chromaticity of the light sources is adjusted such that the chromaticity of the output light from the liquid crystal panel became substantially white. Specifically, chromaticity is adjusted by adjusting the type, the content (compositional ratio), and the like of the phosphors of the light source. In the comparative examples, the color sections had the same area ratio and the same film thickness. The brightness ratio according to the second comparative example is a relative value with the brightness value of the first comparative example defined as the 100% (reference). The brightness ratio according to the fourth comparative example is a relative value with the brightness value of the third comparative example defined as the 100%.

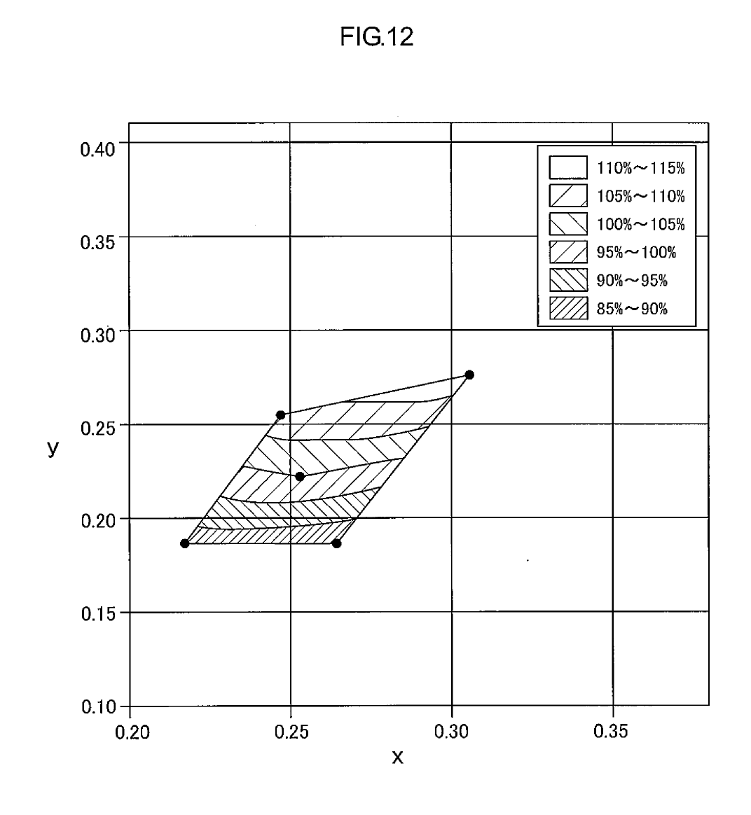

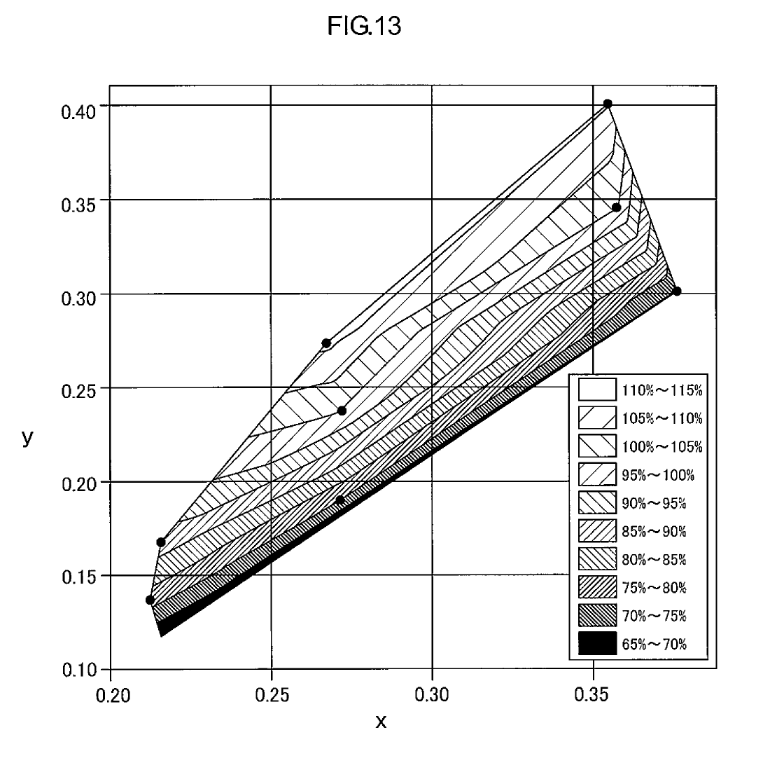

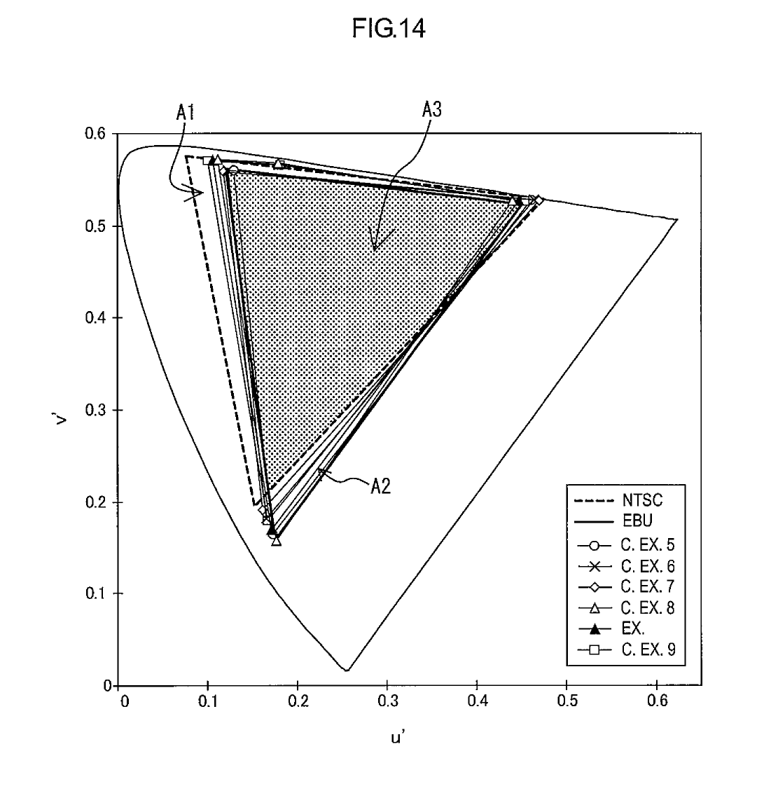

The x and y values in Table 1 are the values of the chromaticity coordinates in the CIE (Commission Internationale de l'Eclairage) 1931 chromaticity diagrams shown in FIGS. 12 and 13. According to the present embodiment, the coordinates as the reference for “white” are (0.272, 0.277) in the CIE1931 chromaticity diagrams shown in FIGS. 12 and 13. As both the x and y values are decreased from the white reference coordinates, the chromaticity is shifted toward blue (i.e., bluishness is enhanced). Conversely, as both the x and y values are increased, the chromaticity is shifted toward yellow (i.e., yellowishness is enhanced). The u′ and v′ values in Table 1 are the values of the chromaticity coordinates in the CIE1976 chromaticity diagrams shown in FIG. 14. According to the present embodiment, the coordinates as a reference for “white” are at (0.1882, 0.4313) in the CIE1976 chromaticity diagrams shown in FIG. 14. As the v′ value decreases from the white reference coordinates, the chromaticity is shifted toward blue (i.e., bluishness is enhanced). Conversely, as the v′ value increases, the chromaticity is shifted toward yellow (i.e., yellowishness is enhanced).

Table 1

A comparison of the results of the first and second comparative examples and the results of the third and fourth comparative examples, which are shown in Table 1, indicates that, even when the light source is subjected to chromaticity adjustment for the liquid crystal panel of the four colors, the brightness of output light is increased and no decrease in brightness is observed in each case. However, a comparison of the results of the second and fourth comparative examples indicates that, when the light source is subjected to chromaticity adjustment for the liquid crystal panel of the four colors, for the cold cathode tube, the brightness as the light source is relatively greatly decreased, and that the increase ratio of the brightness of the output light is relatively low, compared to the LED. One of the reasons for such results is believed that the manner of change in brightness as a result of chromaticity adjustment depends on the type of the light source; namely, it is due to difference in chromaticity-brightness characteristics. This will be described below with reference to FIGS. 12 and 13 showing the chromaticity-brightness characteristics of each light source. FIGS. 12 and 13 are the CIE1931 chromaticity diagrams in which the x-axis or the horizontal axis and the y-axis or the vertical axis show the x value and y value, respectively, of the chromaticity values. According to the present embodiment, each of regions with equal brightness of the two light sources is shown with a different hatching, the values (%) in the legend indicating relative brightness values; namely, brightness ratios. The chromaticity-brightness characteristics of the LED shown in FIG. 13 have lines dividing the regions with equal brightness or “brightness-contour lines” which are inclined generally toward upper right with respect to the x-axis and the y-axis. Thus, the brightness of the LED does not tend to decrease greatly when the chromaticity is shifted toward blue for chromaticity adjustment. On the other hand, the chromaticity-brightness characteristics of the cold cathode tube shown in FIG. 12 have the brightness-contour lines generally parallel to the x-axis. Thus, the brightness of the cold cathode tube tends to relatively greatly decrease compared to the LED when the chromaticity is shifted toward blue for chromaticity adjustment. This supposedly affects the difference in the brightness increase ratio in the output light. Another possible reason is believed that the cold cathode tube may be less compatible with the liquid crystal panel of the four primary color type in terms of spectral characteristics than the LED, resulting in the relative decrease in brightness of the output light.

The present embodiment is based on the configuration using the LED 24 as the light source, by which relatively high brightness can be obtained compared to the cold cathode tube, as described above. In this case, the issue is what phosphor is used in the LEDs 24. Specifically, for the green phosphor emitting light upon excitation by the blue light from the LED chip, when the dominant emission wavelength is set to the value on the longer wavelength side in the range of 480 nm to 580 nm, preferably the range of 500 nm to 560 nm, i.e., the green wavelength region, namely, the value close to the yellow wavelength region (580 nm to 600 nm), the resultant brightness would tend to be higher, which is preferable in the viewpoint of increasing brightness. However, because the value on the longer wavelength side is close to the yellow wavelength region, the wavelength of such value approximates the wavelength of the transmitted light through the yellow color section Y in the color filter of the liquid crystal panel of the four primary color type. Thus, if the value on the longer wavelength side is selected as the dominant emission wavelength, color reproducibility may decrease. On the other hand, when the dominant emission wavelength of the green phosphor is set to the wavelength on the relatively shorter wavelength side in the range of 480 nm to 580 nm, preferably the range of 500 nm to 560 nm, i.e., the green wavelength region, compared to the above longer wavelength side, the dominant emission wavelength is shifted away from the transmitted light through the yellow color section Y. In this case, it may be expected that the color reproducibility will be extended; however, the brightness may be decreased. Accordingly, it is difficult to satisfy both brightness and color reproducibility requirements with only one type of green phosphor.

Thus, in the LEDs 24 according to the present embodiment, the green phosphors that emit light upon excitation by the blue light from the LED chip has two types with different dominant emission wavelengths in the range of 480 nm to 580 nm, and thereby both the brightness and color reproducibility requirements can be satisfied. The two types of green phosphors have the dominant emission wavelengths preferably in the range of 500 nm to 560 nm, i.e., the green wavelength region. According to the present embodiment, the two types of green phosphors include a first phosphor with the dominant emission wavelength on the relatively shorter wavelength side and a second phosphor with the dominant emission wavelength on the relatively longer wavelength side. Specifically, the first phosphor has the dominant emission wavelength of 530 nm and is made of β-SiAlON, for example, which is a type of SiAlON-based phosphor. The second phosphor has the dominant emission wavelength of 540 nm and is made of β-SiAlON, for example, which is a type of SiAlON-based phosphor. Thus, the second phosphor on the longer wavelength side has the dominant emission wavelength relatively close to the yellow wavelength region (580 nm to 600 nm), while the first phosphor on the shorter wavelength side has the dominant emission wavelength relatively far from the yellow wavelength region. Further, the dominant emission wavelength of the second phosphor on the longer wavelength side is relatively close to the peak wavelength of 555 nm in the luminosity factor, while the dominant emission wavelength of the first phosphor on the shorter wavelength side is relatively far from the peak wavelength of 555 nm in the luminosity factor. Preferably, the first and second phosphors are contained in substantially equal amounts in terms of weight ratio or volume ratio. The difference in dominant emission wavelength between the first and second phosphors may be 10 nm. The wavelength range of 480 nm to 580 nm includes the green wavelength region (500 nm to 560 nm), the blue-green wavelength region (480 nm to 500 nm), and the yellow-green wavelength region (560 nm to 580 nm).

The SiAlON-based phosphors including the first phosphor and the second phosphor according to the present embodiment will be described. The SiAlON-based phosphor is a substance constituted by silicon nitride of which silicon atoms are partially substituted by aluminum atoms and nitrogen atoms are partially substituted by oxygen atoms; namely, a nitride. The SiAlON-based phosphor, which is a nitride, has superior emission efficiency and high durability compared to other phosphors of a sulfide or an oxide, for example. That “high durability” means that the brightness of the phosphor is not easily decreased over time due to exposure to high energy of excitation light from the LED chip, for example. The SiAlON-based phosphor may use a rare-earth element (such as Tb, Yg, or Ag) as an activator. The dominant emission wavelength of the SiAlON-based phosphor may be changed (i.e., shifted toward the longer wavelength side or the shorter wavelength side) by varying its composition. For example, the dominant emission wavelength can be changed by adjusting the content of aluminum with which silicon atoms of the silicon nitride are partially substituted; the content of oxygen atoms with which nitrogen atoms are partially substituted; or the type and content of the rare-earth element used as the activator. The β-SiAlON, which is a type of SiAlON-based phosphor, is a substance expressed by the general formula Si_{6-z}Al_{z}O_{z}N_{8-z} (z is amount of solid solution) in which aluminum and oxygen are dissolved in the β-type silicon nitride crystal, or (Si,Al)₆(O,N)₈. According to the present embodiment, Eu (europium) may be used as the activator for the β-SiAlON.

Further, according to the present embodiment, the LEDs 24 include, in addition to the first phosphor and the second phosphor, one type of red phosphor with the dominant emission wavelength in the range of 580 nm to 780 nm and preferably in the range of 600 nm to 780 nm, i.e., a red wavelength region. This red phosphor is referred to as the third phosphor. Preferably, the third phosphor has the dominant emission wavelength in the range of 610 nm to 650 nm in the red wavelength region, such as 638 nm. The third phosphor includes a CASN-based phosphor, for example. The CASN-based phosphor is a nitride containing calcium atoms (Ca), aluminum atoms (Al), silicon atoms (Si), and nitrogen atoms (N). Compared to other phosphor of a sulfide or an oxide, for example, the CASN-based phosphor has superior emission efficiency and high durability. The CASN-based phosphor may use a rare-earth element (such as Tb, Yg, or Ag) as an activator. According to the present embodiment, a CASN expressed by the composition formula CaAlSiN₃:Eu is used as the CASN-based phosphor in which Eu (europium) is used as the activator. The wavelength range of 580 nm to 780 nm includes the red wavelength region and the yellow wavelength region (580 nm to 600 nm).

The CIE1976 chromaticity diagram shown in FIG. 14 will be described in detail. A triangle shown in broken lines in FIG. 14 indicates a NTSC (National Television System Committee) chromaticity region A1 according to a NTSC standard. A triangle shown in solid line in FIG. 14 indicates an EBU (European Broadcasting Union) chromaticity region A2 according to an EBU standard. A quadrangle shown in hatching in FIG. 14 indicates a common region A3 of the NTSC chromaticity region A1 and the EBU chromaticity region A2. The NTSC chromaticity region A1, the EBU chromaticity region A2, and the common region A3 are defined by the chromaticity coordinates shown in Table 2 below. In Table 2, the u′ and v′ values correspond to the values described with reference to Table 1.

The NTSC chromaticity region A1, the EBU chromaticity region A2, and the common region A3 will be described in detail. The NTSC chromaticity region A1 is defined by the chromaticity coordinates shown in Table 2. Specifically, in the CIE1976 chromaticity diagram shown in FIG. 14, the NTSC chromaticity region A1 has the values of (u′, v′) in a region within a triangle with the vertices at the three points of a green primary color point (0.0757, 0.5757), a blue primary color point (0.1522, 0.1957), and a red primary color point (0.4769, 0.5285). The EBU chromaticity region A2 is defined by the chromaticity coordinates shown in Table 2, in the CIE1976 chromaticity diagram of FIG. 14, the EBU chromaticity region A2 has the values of (u′, v′) in a region within a triangle with the vertices at the three points of a green primary color point (0.125, 0.5625), a blue primary color point (0.1754, 0.1579), and a red primary color point (0.4507, 0.5229).

The common region A3 is defined by the quadrangular region in which the two triangles of the NTSC chromaticity region A1 and the EBU chromaticity region A2 overlap with each other. The common region A3 is a chromaticity region required by both the NTSC standard and the EBU standard and is therefore a very important region in maintaining more than predetermined level of display image display quality (color reproducibility). Specifically, in the CIE1976 chromaticity diagram shown in FIG. 14, the common region A3 is the region with the values of (u′, v′) within the quadrangle with the vertexes at the four points of (0.125, 0.5625); (0.1686, 0.2125) at which a line connecting the red and blue primary color points in the NTSC chromaticity region A1 (RB line) intersects a line connecting the blue and green primary color points in the EBU chromaticity region A2 (BG line); (0.3801, 0.4293) at which the RB line in the NTSC chromaticity region A1 intersects the RB line in the EBU chromaticity region A2; and (0.4507, 0.5229).

Table 2

<Second Comparative Experiment>

A second comparative experiment is conducted to verify the superiority of using the LEDs 24 including the first phosphor, the second phosphor, and the third phosphor in combination with the liquid crystal panel 11 of the four primary color type. The results are shown in Tables 3 and 4 and FIGS. 14 to 16. Specifically, the second comparative experiment involves a first experimental example in which a liquid crystal panel of the three primary color type is combined with a backlight unit using LEDs as the light sources, and a second experimental example in which a liquid crystal panel of the four primary color type is combined with a backlight unit using LEDs as the light sources. In each of the experimental examples, the luminous flux ratio (brightness ratio) of the LEDs, the brightness ratio of the output light of the liquid crystal panel, the NTSC ratio indicating the color reproduction range of the output light, and the chromaticity of the output light are measured in accordance with variation of the phosphors contained in the LEDs.

The first experimental example using the liquid crystal panel of the three primary color type, as shown in Table 3, involves a fifth comparative example using two types of phosphors, including the β-SiAlON with the dominant emission wavelength of 540 nm (the second phosphor) and the CASN with the dominant emission wavelength of 638 nm (the third phosphor); a sixth comparative example using three types of phosphors, including the β-SiAlON with the dominant emission wavelength of 530 nm (the first phosphor), the β-SiAlON with the dominant emission wavelength of 540 nm (the second phosphor), and the CASN with the dominant emission wavelength of 638 nm (the third phosphor); and a seventh comparative example using two types of phosphors, including the β-SiAlON with the dominant emission wavelength of 530 nm (the first phosphor) and the CASN with the dominant emission wavelength of 638 nm (the third phosphor). On the other hand, as shown in Table 4, the second experimental example using the liquid crystal panel of the four primary color type involves an eighth comparative example using two types of phosphors, including the β-SiAlON with the dominant emission wavelength of 540 nm (the second phosphor) and the CASN with the dominant emission wavelength of 638 nm (the third phosphor); an exemplary example using three types of phosphors, including the β-SiAlON with the dominant emission wavelength of 530 nm (the first phosphor), β-SiAlON (the second phosphor) with the dominant emission wavelength of 540 nm, and the CASN with the dominant emission wavelength of 638 nm (the third phosphor); and a ninth comparative example using two types of phosphors, including β-SiAlON with the dominant emission wavelength of 530 nm (the first phosphor) and the CASN with the dominant emission wavelength of 638 nm (the third phosphor). In the sixth comparative example and the exemplary example, the β-SiAlON with the dominant emission wavelength of 530 nm (the first phosphor) and the β-SiAlON with the dominant emission wavelength of 540 nm (the second phosphor) are contained in substantially equal amounts in terms of weight ratio or volume ratio.

Next, the values in Tables 3 and 4 will be described in detail. In the fifth to ninth comparative examples and the exemplary example, the luminous flux ratio of the LEDs and the brightness ratio and chromaticity of the output light are determined, in the same way as in the first comparative experiment, by measuring the light transmitted through the color sections R, G, and B (and Y) in the color filter 19 by using a spectrophotometer, for example. The chromaticity measurement of the respective colors in output light is conducted by transmitting light through the color sections R, G, B, and Y in the color filter 19 while the driving of the TFTs 14 is controlled to display the respective colors. Specifically, with regard to the “output light at the time of yellow display”, for example, the transmitted light is measured while controlling the driving of the respective TFTs 14 such that the transmittance through the yellow color section Y is substantially 100% while the transmittance through the other color sections R, G, and B is substantially 0%. Measurement for the other colors is similarly conducted. The chromaticity of the output light according to each of the fifth to ninth comparative examples and the exemplary example is plotted in the CIE1976 chromaticity diagram in FIG. 14. Specifically, the chromaticity regions according to the fifth to seventh comparative examples are indicated by the triangular regions enclosed by the three primary color points of R, G, and B. The chromaticity regions according to the eighth and the ninth comparative examples and the exemplary example are indicated by the quadrangle region enclosed by the four primary color points of R, G, B, and Y. The chromaticity adjustment for the LEDs is made by adjusting the content of the phosphors such that the chromaticity of the output light from the liquid crystal panel becomes generally white. The “white” herein corresponds to the coordinates (0.1882, 0.4313) of the u′ and v′ values in the CIE1976 chromaticity diagram in FIG. 14. With regard to the first experimental example, the luminous flux ratio of the LEDs and the brightness ratio of the output light shown in Table 3 are relative values with the luminous flux value of the LEDs and the brightness value of the output light according to the fifth comparative example defined as 100% (reference). Similarly, with regard to the second experimental example, the luminous flux ratio of the LEDs and the brightness ratio of the output light shown in Table 4 are relative values with the luminous flux value of the LEDs and the brightness value of the output light according to the eighth comparative example defined as 100% (reference). Thus, the luminous flux ratio of the LEDs and the brightness ratio of the output light according to the fifth comparative example shown in Table 3 do not have the same values as the luminous flux ratio of the LEDs and the brightness ratio of the output light according to the eighth comparative example shown in Table 4.

The NTSC ratio indicating the chromaticity region (color reproduction range) of the output light is the area ratio of the chromaticity region of the output light measured in each of the fifth to ninth comparative examples and the exemplary example against the NTSC chromaticity region A1. When the NTSC ratio value is 70% or more in the CIE1976 chromaticity diagram, it may be said that sufficient color reproducibility, i.e., display quality, is ensured in viewing the liquid crystal display device 10. The NTSC ratio of the EBU chromaticity region A2 is 72%. Therefore, when the value of the chromaticity region of the output light is 72% or more, the chromaticity region of the same or higher level with or than the EBU standard may be ensured, leading to better display quality. Throughout the fifth to seventh comparative examples in the first experimental example, the color sections have same area ratio and film thickness. Similarly, throughout the eighth and the ninth comparative examples and the exemplary example in the second experimental example, the color sections have same area ratio and the film thickness.

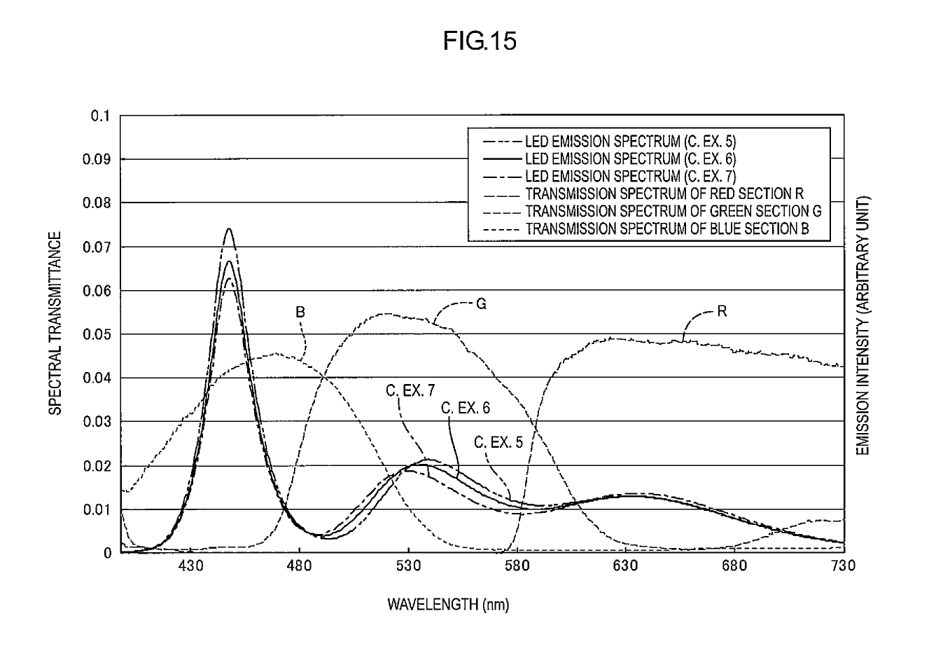

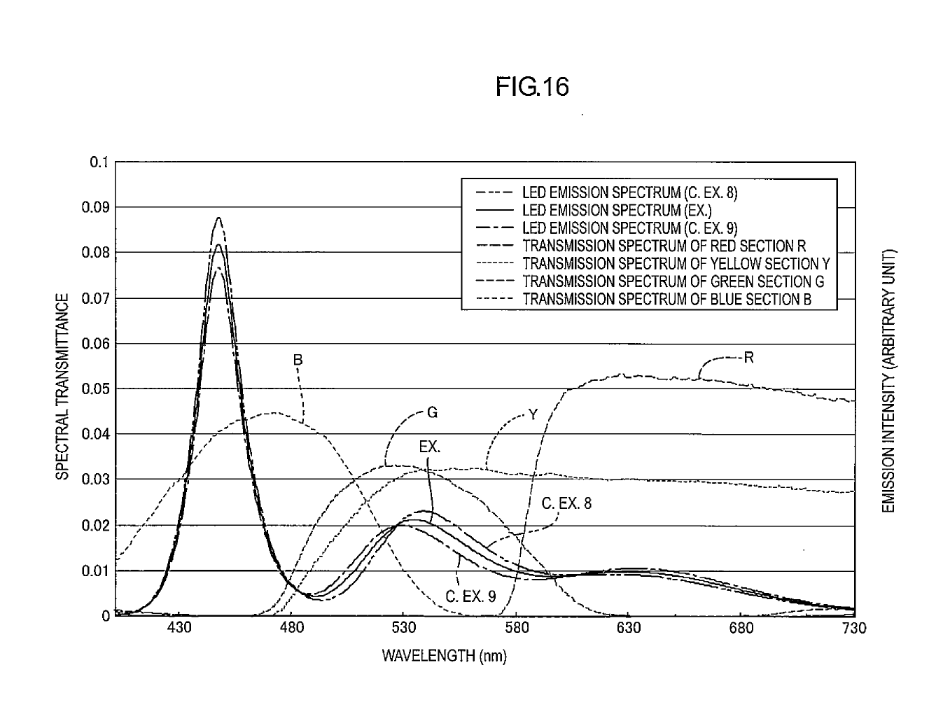

FIG. 15 shows the transmission spectra of the color sections R, G, and B in the color filter of the liquid crystal panel of the three primary color type according to the first experimental example, and the emission spectra of the LEDs used in the fifth to seventh comparative examples. Similarly, FIG. 16 shows the transmission spectra of the color sections R, G, B, and Y in the color filter of the liquid crystal panel of the four primary color type according to the second experimental example, and the emission spectra of the LEDs used in the eighth and ninth comparative examples and the exemplary example. The transmission spectra and emission spectra are measured by using a predetermined spectrophotometer. In FIGS. 15 and 16, the vertical axes have two different units; i.e., the unit “spectral transmittance” for the transmission spectra of the color sections R, G, and B (and Y) shown to the left in FIGS. 15 and 16, and the unit “emission intensity (arbitrary unit)” for the emission spectra of the LEDs, shown to the right in FIGS. 15 and 16. Specifically, the unit for the emission spectrum of the LEDs may be radiance (W/sr·m²), radiation flux (W), or irradiance (W/m²). Other physical quantity related to the amount of radiation may be used.

Table 3

Table 4

First, the results of the first experimental example using the liquid crystal panel of the three primary color type will be discussed. A comparison of the fifth to seventh comparative examples indicates that in the sixth comparative example, the luminous flux ratio of the LEDs, the brightness ratio of the output light, and the NTSC ratio are all lower than those in the fifth comparative example, and that in the seventh comparative example, the luminous flux ratio of the LEDs, the brightness ratio of the output light, and the NTSC ratio are even lower than those in the sixth comparative example. This means that when the dominant emission wavelength of the phosphor which is in the range of 480 nm to 580 nm (green phosphor) is shifted toward the shorter wavelength side, the brightness of the LEDs per se is decreased. As a result, the brightness of the output light from the liquid crystal panel is decreased and even the color reproduction range is also reduced. The reason for the decrease in brightness is believed that the dominant emission wavelength of the phosphor is shifted toward the shorter wavelength side, i.e., from 540 nm to 530 nm, to be away from both the yellow wavelength region (580 nm to 600 nm) and the peak wavelength 555 nm of the luminosity factor. Another possible reason is that the β-SiAlON with the dominant emission wavelength of 530 nm, i.e., the first phosphor on the shorter wavelength side, may be inferior to the β-SiAlON with the dominant emission wavelength of 540 nm, i.e., the second phosphor on the longer wavelength side, in terms of emission efficiency. The reason why the color reproduction range is reduced in addition to the decrease in brightness may be as follows: the β-SiAlON with the dominant emission wavelength of 530 nm is closer to the peak wavelength (500 nm to 520 nm in FIG. 15) of the transmitted light from the green color section G in comparison to the β-SiAlON with the dominant emission wavelength of 540 nm; namaly, the first phosphor on the shorter wavelength side is closer to the peak wavelength of the transmitted light from the green color section G in comparison to the second phospher on the longer wavelength side.

Next, the results of the second experimental example using the liquid crystal panel of the four primary color type will be discussed. A comparison of the eighth and ninth comparative examples and the exemplary example indicates that, while in the exemplary example, the luminous flux ratio of the LEDs and the brightness ratio of the output light are lower, NTSC ratio is improved, compared to those of the eighth comparative example. The comparison also indicates that in the ninth comparative example, the NTSC ratio is even more improved, although the luminous flux ratio of the LEDs and the brightness ratio of the output light are lower than those of the exemplary example. Thus, the luminous flux ratio of the LEDs and the brightness ratio of the output light are gradually decreased in the order of the eighth comparative example, the exemplary example, and the ninth comparative example; namely, as the dominant emission wavelength of the phosphor (green phosphor), which is in the range of 480 nm to 580 nm, is shifted toward the shorter wavelength side. On the other hand, the color reproducibility is gradually increased in the order of the eighth comparative example, the exemplary example, and the ninth comparative example; namely, as the dominant emission wavelength of the phosphor is shifted toward the shorter wavelength side. This means that when the dominant emission wavelength of the phosphor in the range of 480 nm to 580 nm is shifted toward the shorter wavelength side, although the brightness of the LEDs per se is decreased with a corresponding decrease in the brightness of the output light from the liquid crystal panel, the color reproduction range is expanded. The reason for the decrease in brightness is the same as in the first experimental example, but the reason for the expansion of the color reproduction range is following. The liquid crystal panel of the four primary color type used in the second experimental example has the yellow color section Y in addition to the red, green, and red color sections R, G, and B. The β-SiAlON with the dominant emission wavelength of 530 nm is farther from the peak wavelength (560 nm to 600 nm in FIG. 16) of the transmitted light from the yellow color section Y in comparison to the β-SiAlON with the dominant emission wavelength of 540 nm. Namely, the first phosphor on the shorter wavelength side is farther from the peak wavelength of the transmitted light from the yellow color section Y in comparison to the second phosphor on the longer wavelength side. Therefore, the expansion in color reproduction range is obtained. In addition, the dominant emission wavelengths of the first and second phosphors of 530 nm and 540 nm lie both within the wavelength region (520 nm to 560 nm) between the above-mentioned peak wavelength of the transmitted light from the yellow color section Y and the peak wavelength of the transmitted light from the green color section G (500 nm to 520 nm in FIG. 16), leading to further improved color reproducibility.

A detailed comparison of the eighth and ninth comparative examples and the exemplary example indicates that the eighth comparative example using the second phosphor instead of the first phosphor is the most superior in brightness but the most inferior in color reproducibility, whereas the ninth comparative example using the first phosphor instead of the second phosphor is the most superior in color reproducibility but the most inferior in brightness. Thus, the eighth and ninth comparative examples are both insufficient to satisfy both the brightness and color reproducibility requirements. In contrast, in the exemplary example in which both the first and second phosphors are used, sufficiently good results are obtained in both the brightness and color reproducibility. Accordingly, the exemplary example may be considered to be the most superior in terms of achieving both high brightness and excellent color reproducibility.

It is also seen that, as a common tendency of the first and second experimental examples, when the dominant emission wavelength of the phosphor (green phosphor) in the range of 480 nm to 580 nm is shifted toward the shorter wavelength side, both the red and green primary color points are shifted in the direction of expanding the color reproduction region, while the blue primary color point is shifted in the direction of contracting the color reproduction region, as shown in FIG. 14. This is supposedly due to that in the first experimental example, as shown in FIG. 15, the emission intensity of blue light in the LED emission spectra at the peak wavelength (near 450 nm) is gradually decreased in the order of the fifth, sixth, and seventh comparative examples, i.e., as the dominant emission wavelength of the phosphor is shifted toward the shorter wavelength side. Similarly, in the second experimental example, as shown in FIG. 16, the emission intensity of blue light in the LED emission spectra at the peak wavelength (near 450 nm) is gradually decreased in the order of the eighth comparative example, the exemplary example, and the ninth comparative example, i.e., as the dominant emission wavelength of the phosphor is shifted toward the shorter wavelength side.

A comparison of the first experimental example and the second experimental example indicates the same results as those of the first comparative experiment in terms of the color reproducibility of the output light and the chromaticity of the LEDs. Specifically, the second experimental example exceeds the first experimental example in terms of the NTSC ratio value, which means that improved color reproducibility can be obtained by using the liquid crystal panel of the four primary color type including the yellow color section Y. On the other hand, in terms of the chromaticity of the LEDs, the second experimental example is shifted toward blue more than the first experimental example. This is believed as a result of adjusting the chromaticity of the LEDs toward blue, which is the complementary color to yellow, in accordance with the liquid crystal panel of the four primary color type including the yellow color section Y.

The blue, green, yellow, and red chromaticities (blue, green, yellow, and red primary color points) of the output light of the exemplary example all lie outside the common region A3 in the CIE1976 chromaticity diagram shown in FIG. 14. As mentioned above, the common region A3 is a very important region in maintaining a certain level of display quality (color reproducibility) of the display image, and therefore it is preferable to include the common region A3 in the chromaticity region of the output light as much as possible. In this respect, in the exemplary example, the chromaticity of each of the colors is all set to be outside the common region A3. Therefore, most of the common region A3 is included within the chromaticity region of the output light, and sufficient color reproducibility can be ensured when viewing the liquid crystal display device 10. In the exemplary example, the NTSC ratio is in each case 72% or more; thus, color reproducibility equal to or higher than the EBU standard is realized. The chromaticity region of output light herein refers to the quadrangular region with the vertices corresponding to the respective chromaticity of red, blue, yellow, and green of the output light (primary color points) in the exemplary example.

As described above, the liquid crystal display device 10 according to the present embodiment includes: the liquid crystal panel 11 including a pair of substrates 11a and 11b with the liquid crystal layer 11c of liquid crystal between, which is a substrate whose optical characteristics can vary by electric field application; and the backlight unit 12 including a light source to irradiate light onto the liquid crystal panel 11. One of the pair of substrates 11a and 11b of the liquid crystal panel 11 includes the color filter 19 including a plurality of color sections R, G, B, and Y exhibiting the colors of blue, green, red, and yellow, respectively. The backlight unit 12 includes the LEDs 24 as the light sources. The LED 24 includes an LED element as a light emitting source and phosphors that emits light upon excitation by the light from the LED element. The phosphors include at least two types of phosphors with different dominant emission wavelengths in the range of 480 nm to 580 nm.

Thus, the color filter 19 is formed in one of the pair of substrates 11a and 11b of the liquid crystal panel 11, and the color filter 19 includes the yellow color section Y in addition to the color sections R, G, and B of the three primary colors of light, i.e., red, green, and blue. Thus, the color reproduction range that the human eye can perceive, i.e., the color gamut, can be expanded, and also the color reproducibility for the colors of objects in the natural world can be increased. Therefore, improved display quality can be obtained. In addition, the light that transmit through the yellow color section Y of the color sections R, G, B, and Y constituting the color filter 19 has wavelengths close to the peak of luminosity factor. Thus, the light tends to be perceived by the human eye as being bright, i.e., as having high brightness, even when the amount of energy of the light is small. Thus, sufficient brightness can be obtained even when the output of the light sources is restrained, leading to the reduction of the electric power consumption by the light sources and superior environmental friendliness. In other words, the resulting high brightness can be utilized for providing a sharp sense of contrast, thereby enabling further improvement in display quality.

On the other hand, when the yellow color section Y is included in the color filter 19, the output light from the liquid crystal panel 11, i.e., the display image, tends to have yellowishness as a whole. In order to avoid this problem, the chromaticity of the displayed image may be corrected by controlling the amount of transmitted light through the color sections R, G, B, and Y. However, this technique tends to decrease the amount of transmitted light as a result of chromaticity correction, possibly resulting in a decrease in brightness. The present inventor came to the conclusion, after a series of studies, that the chromaticity of the displayed image could be corrected without a decrease in brightness by adjusting the chromaticity of the light source used in the backlight unit 12. In addition, according to the present embodiment, the LEDs 24 are used as the light sources. Compared to other light sources, such as the cold cathode tube, the LEDs 24 can maintain relatively high brightness when the chromaticity is adjusted in accordance with the liquid crystal panel 11 with the yellow color section Y, for example, for reasons including favorable compatibility in spectral characteristics. Thus, the chromaticity of the displayed image can be appropriately corrected without a decrease in brightness.

The present inventor specified the configuration of the LEDs 24 used as the light source that satisfy both the brightness and color reproducibility requirements, after a further series of studies. Namely, according to the present embodiment, the LEDs 24 include the LED element as the light emitting source and the phosphors that emit light upon excitation by the light from the LED element. The phosphors include at least two types of phosphors with different dominant emission wavelengths in the range of 480 nm to 580 nm. Of the at least two types of phosphors, one on the relatively longer wavelength side in the range of 480 nm to 580 nm has the dominant emission wavelength relatively close to the yellow wavelength region. Therefore, this phosphor is superior in terms of brightness. However, this phosphor has the dominant emission wavelength close to the wavelength of the transmitted light through the yellow color section Y in the color filter 19, which is inferior in terms of color reproducibility. On the other hand, of the at least two types of phosphors, one on the relatively shorter wavelength side in the range of 480 nm to 580 nm has the dominant emission wavelength relatively far from the yellow wavelength region, i.e., different from the wavelength of the transmitted light from the yellow color section Y. Therefore, this phosphor is superior in color reproducibility, but inferior in brightness. Thus, it is difficult to satisfy both the brightness and color reproducibility requirements if only one type of phosphors with the dominant emission wavelength in the range of 480 nm to 580 nm is used. In this respect, according to the present embodiment, the two types of phosphors with different dominant emission wavelengths in the range of 480 nm to 580 nm are used, ensuring both high brightness and excellent color reproducibility.

The at least two types of phosphors may have the dominant emission wavelengths in the range of 500 nm to 560 nm. In the at least two types of phosphors with the dominant emission wavelengths in the range of 480 nm to 580 nm, the dominant emission wavelength above 560 nm may be too close to the yellow wavelength region, i.e., the wavelength region of the transmitted light through the yellow color section Y of the color filter 19. Therefore, the color reproducibility may be degraded. Conversely, the dominant emission wavelength below 500 nm may be too far from the yellow wavelength region. Therefore, brightness may be decreased. In this respect, according to the present embodiment, by selecting the dominant emission wavelengths of the at least two types of phosphors from the range of 500 nm to 560 nm, high brightness and excellent color reproducibility can be both achieved in a balanced manner.

The at least two types of phosphors may include a phosphor with the dominant emission wavelength of 530 nm. By thus including the phosphor with the dominant emission wavelength of 530 nm, better color reproducibility can be obtained.

The at least two types of phosphors may include a phosphor with the dominant emission wavelength of 540 nm. By thus including the phosphor with the dominant emission wavelength of 540 nm, even higher brightness can be obtained.

The at least two types of phosphors may include a first phosphor with the dominant emission wavelength of 530 nm and a second phosphor with the dominant emission wavelength of 540 nm. By thus including the phosphor with the dominant emission wavelength of 540 nm, higher brightness can be obtained; in addition, by including the phosphor with the dominant emission wavelength of 530 nm, better color reproducibility can be obtained. Thus, both high brightness and excellent color reproducibility can be achieved in a more preferable manner.

The at least two types of phosphors may include a first phosphor with the dominant emission wavelength on the relatively shorter wavelength side and far from 555 nm, and a second phosphor with the dominant emission wavelength on the relatively the longer wavelength side and relatively close to 555 nm. Because the dominant emission wavelength of the second phosphor on the relatively longer wavelength side is relatively close to 555 nm, i.e., a peak wavelength of the luminosity factor, high brightness can be obtained. On the other hand, because the dominant emission wavelength of the first phosphor on the relatively shorter wavelength side is relatively far from 555 nm, excellent color reproducibility can be ensured. Thus, by using the first phosphor and the second phosphor, both high brightness and excellent color reproducibility can be preferably achieved.

The first and second phosphors may be contained in substantially equal amounts. In this way, high brightness and excellent color reproducibility can be both achieved in an extremely preferable manner.

The difference in dominant emission wavelength between the at least two types of phosphors may be 10 nm. If the difference in dominant emission wavelength between the at least two types of phosphors is less than 10 nm, the difference in brightness and wavelength between the phosphors is too small to satisfy both the brightness and color reproducibility requirements. On the other hand, if the difference in dominant emission wavelength between the at least two types of phosphors is more than 10 nm, the difference in brightness and wavelength between the phosphors is too large to satisfy both the brightness and color reproducibility requirements. In this respect, according to the present embodiment, by setting the difference in dominant emission wavelength between the at least two types of phosphors at 10 nm, both high brightness and excellent color reproducibility can be achieved in a balanced manner.

The at least two types of phosphors may include a SiAlON-based phosphor. In this way, because the SiAlON-based phosphor is a nitride containing at least the four elements of Si, Al, O, and N, excellent emission efficiency and durability can be obtained compared with the case where a sulfide or oxide phosphor is used, for example. In addition, the light emitted by the SiAlON-based phosphor has high color purity compared to light from a YAG-based phosphor, for example. Therefore, the chromaticity adjustment of the LEDs 24 can be more easily performed.

The SiAlON-based phosphor may be β-SiAlON. In this way, better emission efficiency and durability can be obtained. In addition, the light emitted from the β-SiAlON has particularly high color purity. Therefore, the chromaticity adjustment of the LEDs 24 can be more easily performed.

The β-SiAlON may use a rare-earth element (such as Eu, Tb, Yg, or Ag) as an activator and is expressed by the general formula Si_{6-z}Al_{z}O_{z}N_{8-z} (z is the amount of solid solution) in which aluminum and oxygen are dissolved in the β-type silicon nitride crystal.

As the activator for the β-SiAlON, Eu may be used. By using Eu (europium) as the activator among the rare-earth elements, particularly high brightness can be obtained.

The at least two types of phosphors may include a first phosphor with the dominant emission wavelength on the relatively shorter wavelength side and a second phosphor with the dominant emission wavelength on the relatively longer wavelength side. The first phosphor and the second phosphor both are the SiAlON-based phosphors. In this way, both high brightness and excellent color reproducibility can be achieved in a balanced manner.

The phosphors may include at least one type of phosphor with the dominant emission wavelength in the range of 580 nm to 780 nm. By thus including the at least one type of phosphor with the dominant emission wavelength in the range of 580 nm to 780 nm in addition to the at least two types of phosphors with the dominant emission wavelength in the range of 480 nm to 580 nm, better color reproducibility can be obtained.

The at least one type of phosphor may have the dominant emission wavelength in the range of 600 nm to 780 nm. In this way, the dominant emission wavelength of the at least one type of phosphor lies in the red wavelength region. Thus, compared to the dominant emission wavelength in the yellow wavelength region, the dominant emission wavelength of the at least one type of phosphor is relatively far from the dominant emission wavelength (480 nm to 580 nm) of the at least two types of phosphors. Accordingly, even better color reproducibility can be obtained.

The at least one type of phosphor may have the dominant emission wavelength in the range of 610 nm to 650 nm. In this way, even better color reproducibility can be obtained.

The at least one type of phosphor may be a CASN-based phosphor. In this way, because the CASN-based phosphor is a nitride containing at least the four elements of Ca, Al, Si, and N, excellent emission efficiency can be obtained compared to a sulfide or oxide phosphor, for example. For the CASN-based phosphor, a rare-earth element (such as Eu, Tb, Yg, or Ag) may be used as an activator.

The CASN-based phosphor may be CASN (CaAlSiN₃:Eu). By thus using Eu (europium) as the activator among the rare-earth elements, particularly high brightness can be obtained.

The LED element may have the dominant emission wavelength in the range of 380 nm to 480 nm. In order to correct the chromaticity of the displayed image on the liquid crystal panel 11 with the yellow color section Y in addition to the three primary colors of light, it is preferable to adjust the light from the LEDs 24 to have bluishness, on the ground of blue being the complementary color to yellow. In this respect, according to the present embodiment, the LEDs 24 include the LED element that emits light in the blue wavelength region (blue light) to emit blue light with extremely high efficiency. Thus, when the chromaticity of the LEDs 24 is adjusted to have bluish light, brightness does not decrease easily. Therefore, high brightness can be maintained.

The LED element may have the dominant emission wavelength in the range of 440 nm to 460 nm. In this way, even higher brightness can be obtained. The color filter 19 is configured such that the chromaticity of the blue, green, red, or yellow output light obtained by transmitting the light from the LEDs 24 through the respective color sections R, G, B, and Y in the color filter 19 lies outside the common region A3 of the NTSC chromaticity region A1 according to the NTSC standard and the EBU chromaticity region A2 according to the EBU standard in both the CIE1931 chromaticity diagram and the CIE1976 chromaticity diagram. In this way, the common region A3 can be substantially contained in the chromaticity region of the output light. Therefore, sufficient color reproducibility can be ensured.

The “NTSC chromaticity region according to the NTSC standard” refers to the region within the triangle with the vertexes at the three points in which the values of (u′, v′) is of (0.0757, 0.5757), (0.1522, 0.1957), and (0.4769, 0.5285) of the CIE1976 chromaticity diagram. The “EBU chromaticity region according to the EBU standard” refers to the region within the triangle with the vertexes at the three points in which the values of (u′, v′) is of (0.125, 0.5625), (0.1754, 0.1579), and (0.4507, 0.5229) in the CIE1976 chromaticity diagram. The “common region” refers to the region within the quadrangle with the vertexes at the four points in which the values of (u′, v′) is of (0.125, 0.5625), (0.1686, 0.2125), (0.3801, 0.4293), and (0.4507, 0.5229) in the CIE1976 chromaticity diagram.

The chromaticity region of the output light obtained by passing the light from the LEDs 24 through the color section R, G, B, or Y in the color filter 19 may occupy 70% or more in the NTSC chromaticity region according to the NTSC standard. In this way, sufficient color reproducibility in displaying an image can be ensured, leading to good display quality.

The backlight unit 12 includes the chassis 22 housing the LEDs 24, and the optical members 23. The chassis includes the bottom plate 22a arranged on the opposite side to the light output side of the LEDs 24, and the optical members 23 are arranged on the light output side in an opposed manner with respect to the bottom plate 22a and the LEDs 24. In this way, the light emitted from the LEDs 24 is irradiated onto the optical members 23 arranged on the light output side in an opposed manner with respect to the bottom plate 22a and the LEDs 24. After passing through the optical members 23, the light is output toward the liquid crystal panel 11.

On the light output side of the LEDs 24, the diffuser lenses 27 diffusing the light from the LEDs 24 are arranged. In this way, the light emitted from the LEDs 24 can be output while being diffused by the diffuser lenses 27. Thus, unevenness of the output light does not easily occur. Therefore, the number of the LEDs 24 installed can be decreased, leading to cost reduction.

The display panel may be the liquid crystal panel 11 including the liquid crystal layer 11c as the substance whose the optical characteristics vary by application of an electric field. In this way, the display panel can be applied for various purposes, such as for television or personal computer display, particularly for large screens.

The television receiver TV according to the present embodiment includes the liquid crystal display device 10 and the tuner T as a reception unit configured to receive a television signal. According to such a television receiver TV, the liquid crystal display device 10, which displays a television image based on the television signal, can appropriately correct the chromaticity of the display image while high brightness is obtained. Therefore, the television image can be displayed with high display quality.

The television receiver TV further includes the image conversion circuit VC that converts the television image signal output from the tuner T into an image signal of the respective colors of blue, green, red, or yellow. In this way, the television image signal is converted by the image conversion circuit VC into the image signal corresponding to the respective color sections R, G, B, and Y of the blue, green, red, and yellow included in the color filter 19. Therefore, the television image can be displayed with high display quality.

### Second Embodiment

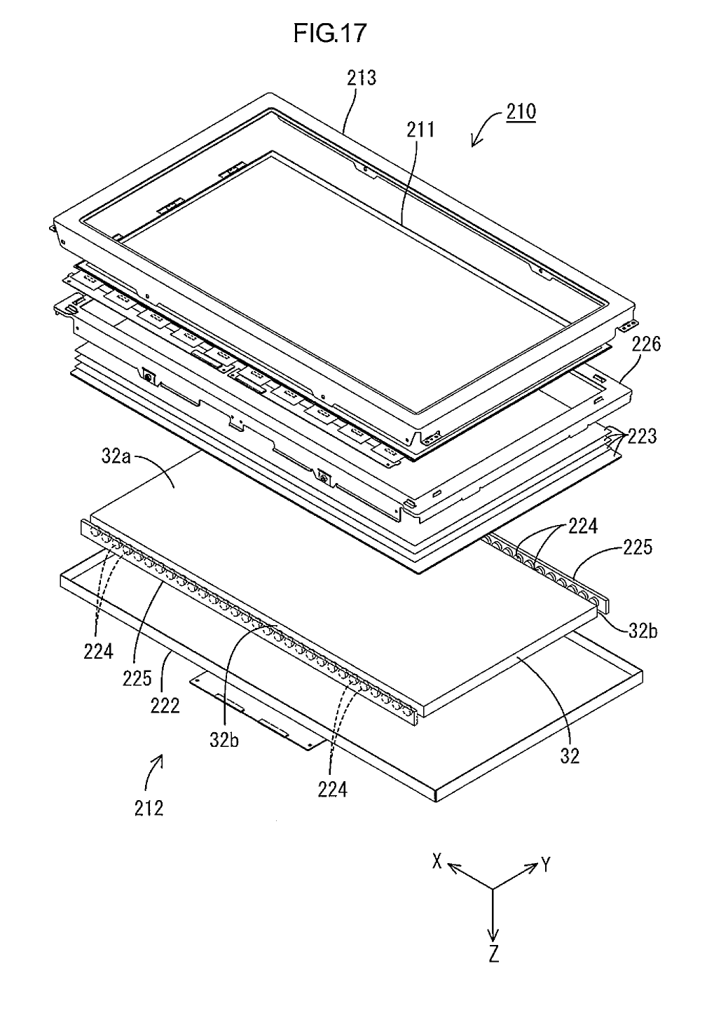

A second embodiment of the present invention will be described with reference to FIGS. 17 to 20. The second embodiment differs from the first embodiment in that a backlight unit 212 of the edge light type is used. Redundant description of structures, operations, and effects similar to those of the first embodiment will be omitted.

A liquid crystal display device 210 according to the present embodiment, as shown in FIG. 17, includes a liquid crystal panel 211 and the edge light backlight unit 212 in an integrated manner using a bezel 213 or the like. The configuration of the liquid crystal panel 211 may be similar to the first embodiment and redundant description will be omitted. In the following, the configuration of the edge light backlight unit 212 will be described.

The backlight unit 212, as shown in FIG. 17, includes a substantially box-shaped chassis 222 with an opening on the light output surface side (the side facing the liquid crystal panel 211); and a group of optical members 223 (a diffuser plate (light diffuser member) 223a and a plurality of optical sheets 223b arranged between the diffuser plate 223a and the liquid crystal panel 211) covering the opening of the chassis 222. The chassis 222 houses LEDs (Light Emitting Diodes) 224 as light sources; LED boards 225 on which the LEDs 224 are mounted; a light guide member 32 that guides the light from the LEDs 224 toward the optical members 223 (the liquid crystal panel 211); and a frame 226 retaining the light guide member 32 from the front side. Each one of the LED boards 225 with the LEDs 224 is arranged at both ends of the backlight unit 212 on the long sides thereof with the light guide member 32 sandwiched between the LED boards 225 at the center. Thus, the backlight unit 212 is of the so-called edge light type (side light type). The backlight unit 212 according to the present embodiment, which is of the edge light type, does not include the diffuser lenses 27, the holding members 28, the first reflection sheet 30, the second reflection sheets 31, or the like included in the direct backlight unit 12 according to the first embodiment. The configuration of the optical members 223 may be similar to the first embodiment and redundant description will be omitted. In the following, the constituent components of the backlight unit 212 will be described in detail.

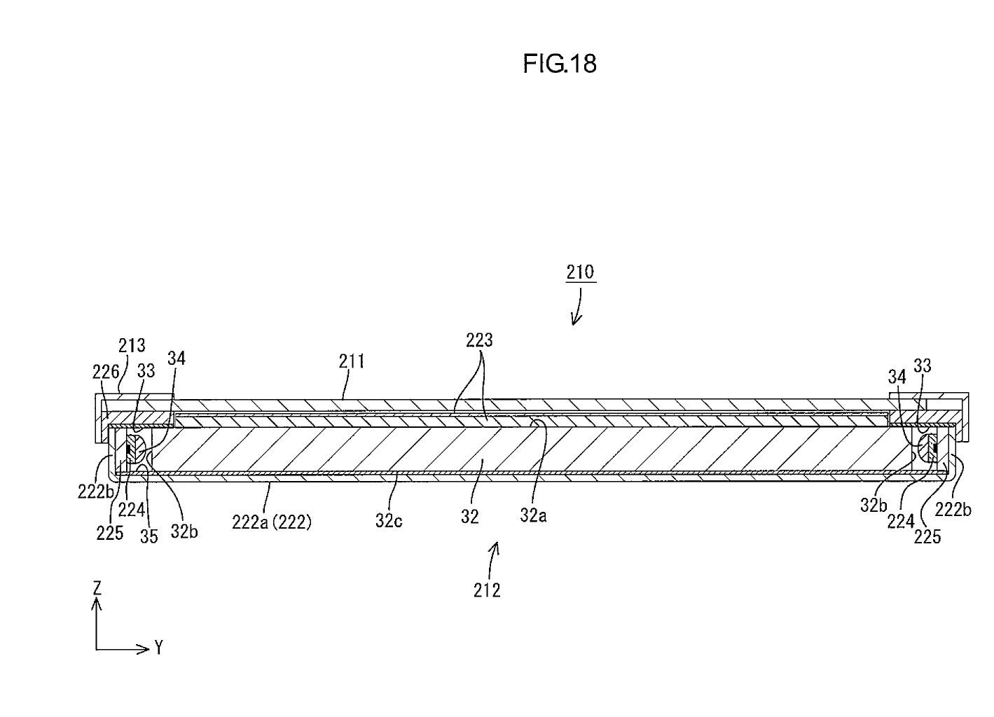

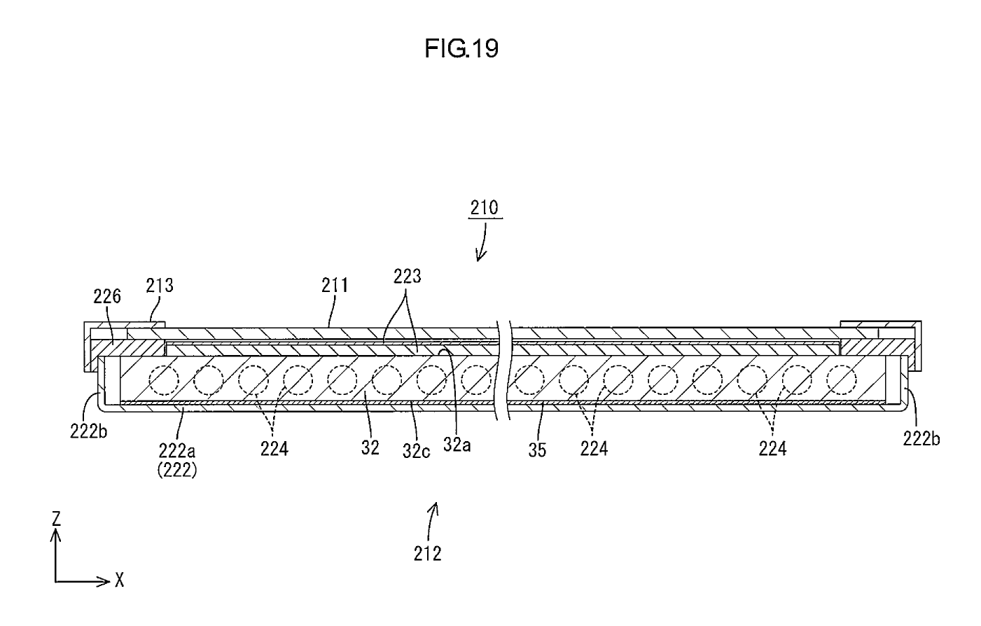

The chassis 222 is made of metal and, as shown in FIGS. 18 and 19, includes a bottom plate 222a with a horizontally long square shape similar to the liquid crystal panel 211, and side plates 222b rising from the outer ends of the sides of the bottom plate 222a. Thus, the chassis 222 as a whole has a shallow, substantially box-like shape with an opening on the front side. The chassis 222 (bottom plate 222a) has a long side direction aligned with the X-axis direction (horizontal direction) and a short side direction aligned with the Y-axis direction (vertical direction). To the side plates 222b, the frame 226 and the bezel 213 can be threadably attached.

The frame 226, as shown in FIG. 17, has a frame-like shape extending along the outer peripheral ends of the light guide member 32 to retain substantially the entire peripheral ends of the light guide member 32 from the front side. The frame 226 has a black surface, for example, of a synthetic resin, providing light blocking property. On the rear side surfaces of both the long side portions of the frame 226, which faces the light guide member 32 and the LED boards 225 (LEDs 224), each one of first reflection sheets 33 reflecting light are attached, as shown in FIG. 18. The first reflection sheets 33 are sized to extend along substantially the entire length of the long side portions of the frame 226. In addition, the first reflection sheets 33 are directly abutted on the end portions of the light guide member 32 on the LED side. Thus, the first reflection sheets 33 cover both the end portions of the light guide member 32 and the LED boards 225 altogether from the front side. The frame 226 is configured to receive the outer peripheral end portions of the liquid crystal panel 211 from the rear side.

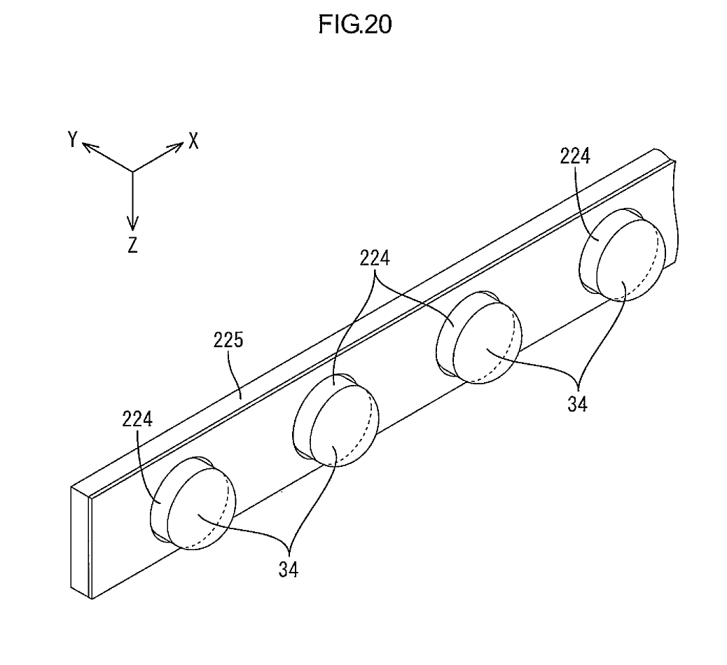

The LEDs 224 are mounted on the LED boards 225, as shown in FIG. 17, to have the light emitting surface on the opposite side of the LED-mounting surface, that is the so-called top type. On the light emitting surface side of the LEDs 224, lens members 34 outputting light while diffusing at large angles are provided, as shown in FIGS. 18 and 20. The lens members 34 are interposed between the LEDs 24 and light entrance surfaces 32b of the light guide member 32. The lens members 34 have a spherical light output surface to be convex toward the light guide member 32. The light output surface of the lens members 34 is curved along the length direction of the light entrance surfaces 32b of the light guide member 32 to have a substantially circular cross section. The configuration of the LEDs 224 may be similar to the first embodiment and redundant description will be omitted.

The LED boards 225, as shown in FIG. 17, have a thin and long plate-like shape extending along the long side direction (the X-axis direction; the longitudinal direction of the light entrance surfaces 32b of the light guide member 32) of the chassis 222, with main plate surfaces parallel with the X-axis direction and the Z-axis direction. Specifically, the LED boards 225 are housed in the chassis 222 with their plate surfaces orthogonal to the plate surfaces of the liquid crystal panel 211 and the light guide member 32 (the optical members 223). The LED boards 225 is arranged as a pair, one at each end of the chassis 222 on the long side thereof, respectively to be attached to the inner surfaces of the side plates 222b on the long side. The LEDs 224 are surface-mounted on the main plate surfaces or the inner side of the LED boards 225, which faces (or is opposed to) the light guide member 32. Specifically, a plurality of the LEDs 224 is arranged side by side in a line on the mounting surface of the LED boards 225 along the length direction thereof (X-axis direction). In other words, a plurality of the LEDs 224 is arranged side by side on each of the end portions of the backlight unit 212 on the long sides along the long side direction. Because the pair of LED boards 225 is housed in the chassis 222 with the mounting surfaces of the LEDs 224 opposed to each other, the light emitting surfaces of the LEDs 224 mounted on the LED boards 225 are opposed to each other, with the optical axes of the LEDs 224 substantially aligned with the Y-axis direction.

The base member of the LED boards 225 may be made of the same metal material as the chassis 222, such as aluminum based material. On the surface of the base member, a wiring pattern (not shown) of a metal film, such as copper foil, is formed via an insulating layer. On the outer-most surface of the base member, a white reflective layer (not shown) with excellent light reflectivity is formed. The LEDs 224 arranged side by side in a line on the LED boards 225 are connected in series by the wiring pattern. As the material of the base member of the LED boards 225, an insulating material, such as ceramic material, may be used.

The light guide member 32 will be described in detail. The light guide member 32 is made of a substantially transparent (highly light transmissive) synthetic resin material (such as acrylic) with a refractive index sufficiently higher than that of air. The light guide member 32, as shown in FIG. 17, has a horizontally long square shape in plan view similar to the liquid crystal panel 211 and the chassis 222, with the long side direction aligned with the X-axis direction and the short side direction aligned with the Y-axis direction. The light guide member 32 is arranged immediately under the liquid crystal panel 211 and the optical members 223 in the chassis 222 to be sandwiched, with respect to the Y-axis direction, between the pair of LED boards 225 arranged at the ends of the chassis 222 on the long sides. Thus, the LEDs 224 (LED boards 225) and the light guide member 32 are arranged along the Y-axis direction, while the optical members 223 (the liquid crystal panel 211) and the light guide member 32 are arranged along the Z-axis direction. The directions of both arrangements are perpendicular to each other. The light guide member 32 has the function of making the light emitted by the LEDs 224 in the Y-axis direction enter therethrough and directing the light upward to output toward the optical members 223 (the Z-axis direction) while allowing the light to travel within the light guide member 32. The light guide member 32 is a little larger than the optical members 223 such that the outer peripheral end portions of the light guide member 32 extend outward beyond the outer peripheral end surfaces of the optical members 223, where is retained by the frame 226 (FIGS. 18 and 19).

The light guide member 32 has a substantially flat plate-like shape, which extends along the plate surfaces of the bottom plate 222a of the chassis 222 and the optical members 223, with main plate surfaces parallel with the X-axis direction and the Y-axis direction. The front-side one of the main plate surfaces of the light guide member 32 constitutes a light output surface 32a, from which the internal light is output toward the optical members 223 and the liquid crystal panel 211. Of the outer peripheral end surfaces adjacent to the main plate surfaces of the light guide member 32, the elongated end surfaces on the long sides extending along the X-axis direction are opposed to the LEDs 224 (the LED boards 225) with a predetermined interval therebetween; namely, the longitudinal end surfaces constitute light entrance surfaces 32b, on which the light emitted by the LEDs 224 enters. The light entrance surfaces 32b are parallel to the X-axis direction and the Z-axis direction and substantially orthogonal to the light output surface 32a. The arrangement direction of the LEDs 224 and the light entrance surfaces 32b is aligned with the Y-axis direction and parallel to the light output surface 32a. The light guide member 32 has a surface 32c opposite to the light output surface 32a, which is entirely covered with a second reflection sheet 35 reflecting the light within the light guide member 32 upward toward the front side. The second reflection sheet 35 extends to areas overlapping with the LED boards 225 (LEDs 224) in plan view to sandwich the LED boards 225 (LEDs 224) with the first reflection sheets 33 on the front side. Thus, the light from the LEDs 224 is repeatedly reflected between the reflection sheets 33 and 35, thereby causing the light to enter on the light entrance surfaces 32b efficiently. At least one of the light output surface 32a and the opposite surface 32c of the light guide member 32 is patterned with a reflecting portion (not shown) reflecting the internal light or a scattering portion (not shown) scattering the internal light, and thereby the output light from the light output surface 32a is controlled to have a uniform in-plane distribution.

As described above, according to the present embodiment, the backlight unit 212 includes the light guide member 32 with the end portions opposed to the LEDs 224. The light from the LEDs 224 is guided through the light guide member 32 toward the liquid crystal panel 211. Generally, the light guide member 32, although with high transparency, often has a slight yellowishness. Thus, as the light emitted by the LEDs 224 passes through the light guide member 32, the transmitted light tends to have a slight yellowishness. In such a case, the chromaticity of the displayed image can be appropriately corrected without a decrease in brightness by adjusting the chromaticity of the LEDs 224 in accordance with the light guide member 32 having the yellowish tone in addition to the liquid crystal panel 211 with the yellow color section Y.

The light guide member 32 includes the elongated light entrance surfaces 32b on the ends facing the LEDs 224, while the LEDs 224 includes the lens members 34 covering the light output side of the LEDs 224 to diffuse light. The lens members 34 are opposed to the light entrance surfaces 32b of the light guide member 32 and curved along the longitudinal direction of the light entrance surfaces 32b to be convex toward the light guide member 32. In this way, the light emitted by the LEDs 224 is spread by the lens members 34 in the longitudinal direction of the light entrance surfaces 32b. Therefore, the dark areas that could be formed at the light entrance surfaces 32b of the light guide member 32 can be decreased. Accordingly, the light with uniform brightness can be obtained throughout the light entrance surfaces 32b of the light guide member 32 even when the distance between the LEDs 224 and the light guide member 32 is short and the number of the LEDs 224 is small.

The backlight unit 212 includes the reflection sheets 33 and 35 between the LEDs 224 and the light guide member 32 along the longitudinal direction of the light entrance surfaces 32b. In this way, the light scattered from the lens members 34 outside the light guide member 32 can be reflected by the reflection sheets 33 and 35 to enter on the light guide member 32. Thus, the light entrance efficiency from the LEDs 224 on the light guide member 32 can be increased.

### Third Embodiment

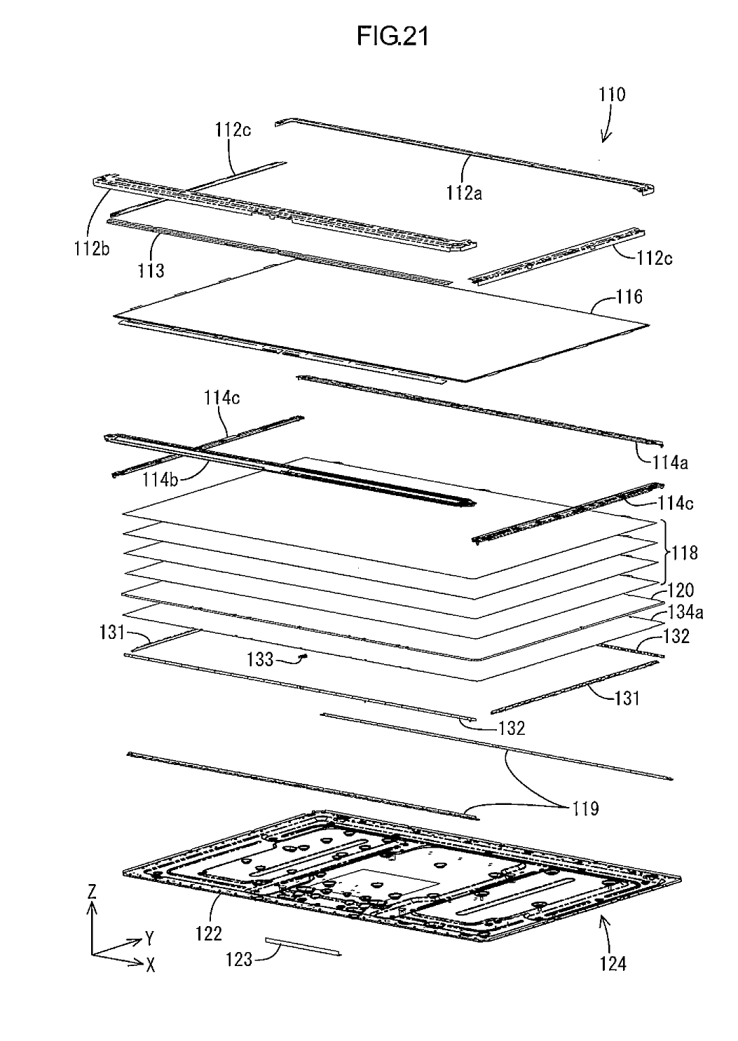

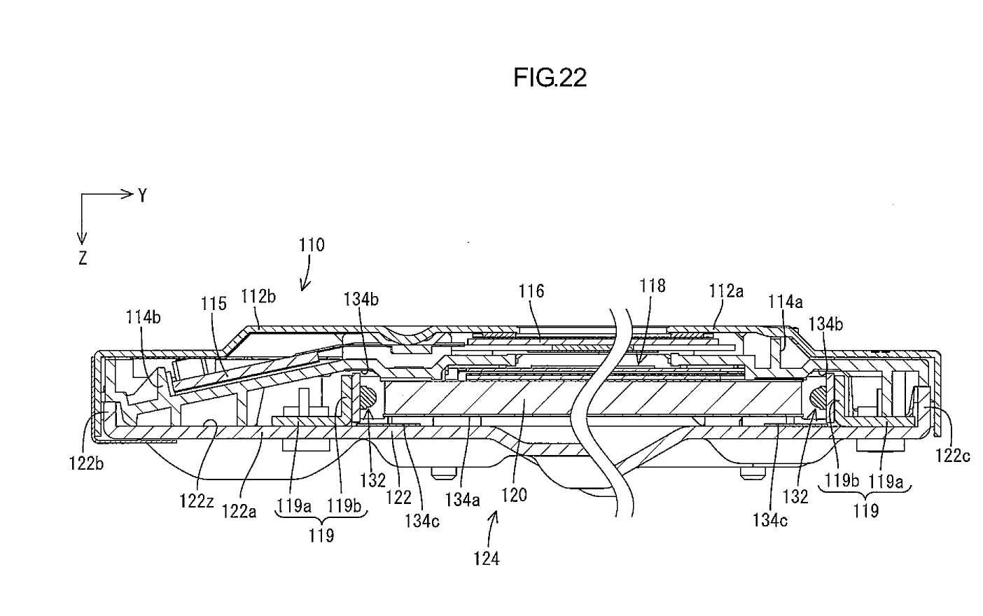

A third embodiment of the present invention will be described with reference to FIG. 21 or 22. The third embodiment differs from the second embodiment in the constituent components of a liquid crystal display device 110. Redundant description of structures, operations, or effects similar to those of the second embodiment will be omitted.

FIG. 21 is an exploded perspective view of the liquid crystal display device 110 according to the present embodiment. In FIG. 22, the upper side corresponds to the front side and the lower side corresponds to the rear side. As shown in FIG. 21, the liquid crystal display device 110 as a whole has a horizontally long square shape, and includes a liquid crystal panel 116 as a display panel and a backlight unit 124 as an external light source, which are configured to be integrally retained by a top bezel 112a, a bottom bezel 112b, side bezels 112c (hereafter referred to as a group of bezels 112a to 112c), and the like. The liquid crystal panel 116 may have a configuration similar to that according to the second embodiment; thus, redundant description of the configuration will be omitted.

In the following, the backlight unit 124 will be described. As shown in FIG. 21, the backlight unit 124 includes a backlight chassis (sandwiching member; support member) 122; optical members 118; a top frame (sandwiching member) 114a; a bottom frame (sandwiching member) 114b; side frames (sandwiching members) 114c (hereafter referred to as the frames 114a to 114c); and a reflection sheet 134a. The liquid crystal panel 116 is sandwiched by the group of bezels 112a to 112c and the frames 114a to 114c. Reference sign 113 indicates an insulating sheet insulating a display control circuit board 115 (see FIG. 22) that drives the liquid crystal panel 116. The backlight chassis 122 is open on the front side (the light output side; the side of the liquid crystal panel 116), and has a substantially box-like shape with a bottom surface. The optical members 118 are arranged on the front side of the light guide plate 120. The reflection sheet 134a is arranged on the rear side of the light guide plate 120. Further, the backlight chassis 122 houses a pair of cable holders 131; a pair of heat dissipating plates (attached heat dissipating plates) 119; a pair of LED units 132; and a light guide plate 120. The LED units 132, the light guide plate 120, and the reflection sheet 134a are held together with rubber bushes 133. On the back surface of the backlight chassis 122, a power supply circuit board (not shown) supplying electric power to the LED units 132, a protection cover 123 protecting the power supply circuit board, and the like are attached. The pair of cable holders 131 is arranged along the short side direction of the backlight chassis 122 and houses wires electrically connecting the LED units 132 and the power supply circuit board.

FIG. 22 is a horizontal cross sectional view of the backlight unit 124. As shown in FIG. 22, the backlight chassis 122 is constituted by a bottom plate 122a with a bottom surface 122z, and side plates 122b and 122c shallowly rising from the outer edges of the bottom plate 122a. The backlight chassis 122 supports at least the LED units 132 and the light guide plate 120. The heat dissipating plate 119 includes a bottom surface portion (second plate portion) 119a and a side surface portion (first plate portion) 119b rising from the outer edges of the bottom surface portion 119a on one long side thereof, forming an L-shape in horizontal cross section. Each of the heat dissipating plates 119 is arranged along the long sides of the backlight chassis 122. The bottom surface portions 119a of the heat dissipating plates 119 are fixed to the bottom plate 122a of the backlight chassis 122. Each of the pair of LED units 132 extends along the long sides of the backlight chassis 122, and is fixed to the corresponding side surface portions 119b of the heat dissipating plates 119 with the light output sides of the LED units 132 opposed to each other. Thus, the pair of LED units 132 is supported by the bottom plate 122a of the backlight chassis 122 via the heat dissipating plates 119. The heat dissipating plates 119 dissipate the heat generated in the LED units 132 outside the backlight unit 124 via the bottom plate 122a of the backlight chassis 122.

As shown in FIG. 22, the light guide plate 120 is arranged between the pair of LED units 132. The pair of LED units 132, the light guide plate 120, and the optical members 118 are sandwiched by the frames (first sandwiching members) 114a to 114c and the backlight chassis (second sandwiching member) 122. Further, the light guide plate 120 and the optical members 118 are fixed by the frames 114a to 114c and the backlight chassis 122. The LED units 132, the light guide plate 120, and the optical members 118 may have configurations similar to those according to the first embodiment; thus, redundant description of the configurations will be omitted.

As shown in FIG. 22, the drive circuit board 115 is arranged on the front side of the bottom frame 114b. The drive circuit board 115 is electrically connected to the display panel 116 and supplies image data and various control signals necessary for image display to the liquid crystal panel 116. A first reflection sheet 134b is arranged on the surface of the top frame 114a at a location that is exposed to the LED units 132, along the long side direction of the light guide plate 120. Another first reflection sheet 134b is arranged on the surface of the bottom frame 114b at a location that is opposed to the LED unit 132, along the long side direction of the light guide plate 120.

### Other Embodiments

The present invention is not limited to the embodiments above described and illustrated with reference to the drawings, and the following embodiments may be included in the technical scope of the present invention.

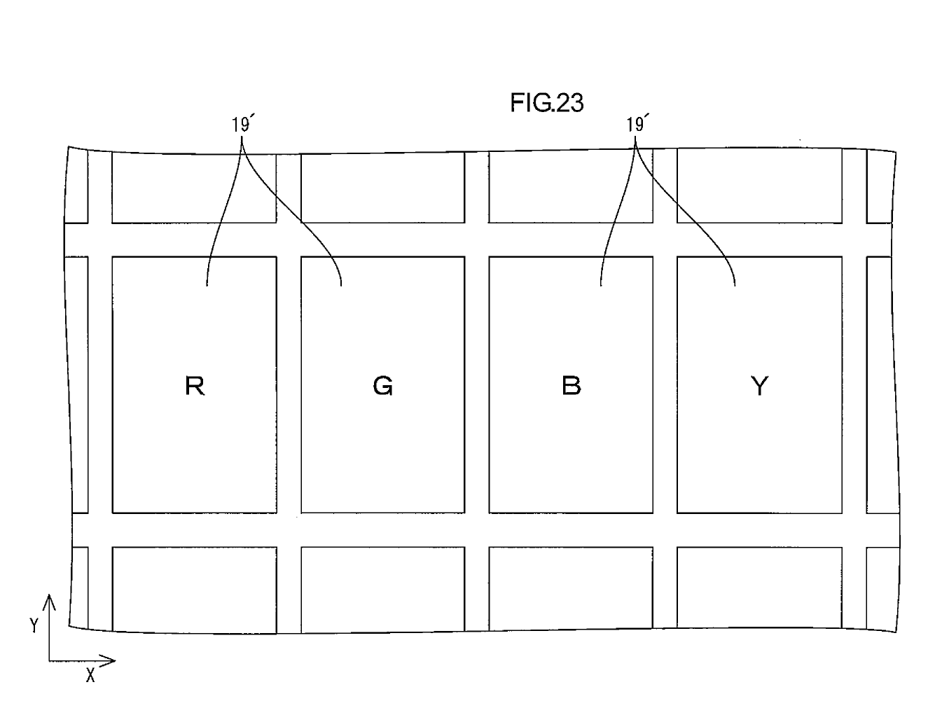

(1) Other than the foregoing embodiments, the order of arrangement of the color sections in the color filter of the liquid crystal panel may be appropriately modified. For example, as shown in FIG. 23, the present invention includes a configuration in which the color sections R, G, B, and Y in a color filter 19′ are arranged in the order of the red color section R, the green color section G, the blue color section B, and the yellow color section Y from the left of the figure along the X-axis direction.

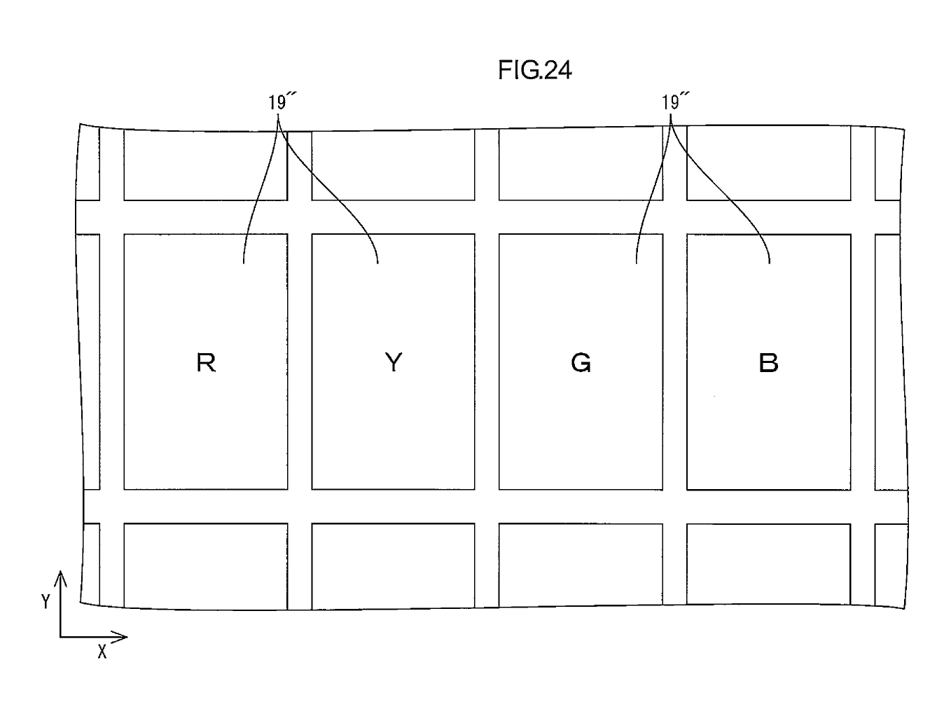

(2) Other than (1), the present invention includes a configuration in which, as shown in FIG. 24, the color sections R, G, B, and Y in a color filter 19′ are arranged in the order of the red color section R, the yellow color section Y, the green color section G, and the blue color section B from the left of the figure along the X-axis direction.

(3) According to the first embodiment, the LEDs contain the first and second phosphors with the dominant emission wavelengths in the range of 480 nm to 580 nm in substantially equal amounts, by way of example. It is also possible to vary the content ratio of the first phosphor and the second phosphor. In this case, the content of the first phosphor may be relatively increased (the content of the second phosphor relatively decreased), or, conversely, the content of the second phosphor may be relatively increased (the content of the first phosphor relatively decreased). In this case, it may be preferable to increase the content ratio of the first phosphor on the shorter wavelength side when priority is to be given to color reproducibility rather than brightness. Conversely, it may be preferable to increase the content ratio of the second phosphor on the longer wavelength side when priority is to be given to brightness rather than color reproducibility. Specifically, the ratio of the contents of the first phosphor and the second phosphor may be appropriately adjusted, for example, to 6:4 (4:6) or 7:3 (3:7).

(4) According to the first embodiment, as the two types of phosphors with the dominant emission wavelengths in the range of 480 nm to 580 nm, the β-SiAlON, which is a SiAlON-based phosphor, is used. It is also possible to use the two types of phosphors of different materials.

(5) As concrete examples of (4), one of the at least two types of phosphors may be the β-SiAlON and the other may be a YAG-based phosphor. In this case, the β-SiAlON may be the first phosphor on the relatively shorter wavelength side and the YAG-based phosphor may be the second phosphor on the relatively longer wavelength side. Conversely, the YAG-based phosphor may be the first phosphor and the β-SiAlON may be the second phosphor. The YAG-based phosphor has a garnet structure including a complex oxide of yttrium and aluminum, which is expressed by the chemical formula Y₃Al₅O₁₂. The YAG-based phosphor uses a rare-earth element (such as Ce, Tb, Eu, or Nd) as an activator. The YAG-based phosphor may have a part or all of the Y site of the chemical formula Y₃Al₅O₁₂ substitutable with Gd or Tb, for example, or a part of the Al site substitutable with Ga, for example. Thus, the dominant emission wavelength of the YAG-based phosphor can be shifted toward the longer wavelength side or the shorter wavelength side for adjustment. Concrete examples of the YAG-based phosphor include Y₃Al₅O₁₂:Ce, Y₃Al₅O₁₂: Tb, (Y,Gd)₃Al₅O₁₂: Ce, Y₃(Al,Ga)₅O₁₂: Ce, Y₃(Al,Ga)₅O₁₂:Tb, (Y,Gd)₃(Al,Ga)₅O₁₂:Ce, (Y,Gd)₃(Al,Ga)₅O₁₂:Tb, and Tb₃Al₅O₁₂:Ce.

(6) Other than (5), the at least two types of phosphor may be YAG-based phosphors.

(7) According to the first embodiment, of the at least two types of phosphor with the dominant emission wavelengths in the range of 480 nm to 580 nm, the first phosphor may have the dominant emission wavelength of 530 nm and the second phosphor has the dominant emission wavelengths of 540 nm. The concrete value of the dominant emission wavelength of the first and second phosphors may be appropriately modified within the range of values.

(8) As a concrete example of (7), the dominant emission wavelength of the first phosphor on the shorter wavelength side may be relatively close to the peak wavelength 555 nm of the luminosity factor, and the dominant emission wavelength of the second phosphor on the longer wavelength side may be relatively far from 555 nm. For example, the dominant emission wavelength of the first phosphor is set at 550 nm and the dominant emission wavelength of the second phosphor is set at 570 nm. In this case, the difference between the dominant emission wavelength of the first and second phosphors is 10 nm or more; such configuration is also included in the present invention.

(9) Other than (8), the difference between the dominant emission wavelength of the first phosphor and the peak wavelength of the luminosity factor, i.e., 555 nm may be equal to the difference between the dominant emission wavelength of the second phosphor and the peak wavelength of the luminosity factor, i.e., 555 nm. For example, the dominant emission wavelength of the first phosphor is set at 550 nm and the dominant emission wavelength of the second phosphor is set at 560 nm.

(10) Other than (8) and (9), the present invention also may include a configuration in which, for example, the difference in the dominant emission wavelength between the first and second phosphors is 10 nm or less. For example, the dominant emission wavelength of the first phosphor is set at 530 nm and the dominant emission wavelength of the second phosphor is set at 539 nm.

(11) Other than (8) to (10), for either one of the first and second phosphors, the dominant emission wavelength may be in the range of 480 nm to 500 nm (outside the range of 500 nm to 560 nm). Similarly, for either one of the first and second phosphors, the dominant emission wavelength may be in the range of 560 nm to 580 nm (outside the range of 500 nm to 560 nm).

(12) According to the first embodiment, the at least two types of phosphor with the dominant emission wavelengths in the range of 480 nm to 580 nm are used. The aspect of the present invention also includes a configuration in which three or more types of phosphor with the different dominant emission wavelengths from the range of 480 nm to 580 nm are used.

(13) In the exemplary example of the second experimental example according to the first embodiment, as the first and second phosphors, the β-SiAlON is used with Eu as the activator. The β-SiAlON with another rare-earth element (such as Tb, Yg, and Ag) as the activator may be used.

(14) According to the first embodiment, as the one type of phosphor (the third phosphor) with the dominant emission wavelength in the range of 580 nm to 780 nm, the CASN, which is a CASN-based phosphor, is used. The other materials, however, may be used.

(15) As a concrete example of (14), α-SiAlON (dominant emission wavelength: 585 nm to 590 nm), which is a SiAlON-based phosphor, may be used as the third phosphor. Other than that, as the third phosphor, a YAG-based phosphor, a BOSE-based phosphor, or a CASN-based phosphor other than the CASN may be used.

(16) According to the first embodiment, the one type of phosphor (the third phosphor) with the dominant emission wavelength in the range of 580 nm to 780 nm has the dominant emission wavelength of 638 nm. The concrete value of the dominant emission wavelength of the third phosphor may be appropriately changed within the above-mentioned range.

(17) As a concrete example of (16), the dominant emission wavelength of the third phosphor may be in the range of 580 nm to 610 nm or the range of 650 nm to 780 nm. In addition, the third phosphor may have the dominant emission wavelength in the range of 580 nm to 600 nm.

(18) According to the first embodiment, the at least one type of phosphor with the dominant emission wavelength in the range of 580 nm to 780 nm is used. The present invention also includes a configuration in which two or more types of phosphors with different dominant emission wavelengths in the range of 580 nm to 780 nm are used.

(19) According to the first embodiment, the dominant emission wavelength of the LED chip is 451 nm. The present invention also includes configurations in which the dominant emission wavelength is shifted from 451 nm toward the longer wavelength side or the shorter wavelength side. Also in these cases, the LED chip preferably has the dominant emission wavelength in the range of 380 nm to 480 nm, and more preferably in the range of 440 nm to 460 nm.

(20) In the foregoing embodiments, the LEDs are of the type including an LED chip that emits the single color of blue light and configured to emit substantially white light (including white light and substantially white and yet bluish light) by using phosphors. The present invention also includes a configuration in which the LEDs are of the type including an LED chip that emits the single color of ultraviolet light (blue-violet light) and configured to emit substantially white light by using phosphors. Also in this case, the chromaticity of the LEDs can be adjusted by appropriately adjusting the contained amount of the phosphors in the LEDs.

(21) According to the first embodiment, the color sections in the color filter contain a pigment. However, the aspec of the present invention also includes a configuration in which the color sections in the color filter contain a dye.

(22) While according to the first embodiment the diffuser lenses are arranged on the light output side of the LEDs, the present invention also includes a configuration in which the diffuser lenses are omitted. The number of LEDs installed on the LED boards, the number of the LED boards (LEDs) installed on the chassis, and the like may be appropriately modified.

(23) In the second and third embodiments, each one of the LED boards (LEDs) is arranged as a pair at the ends of the chassis (light guide member) on the long sides thereof. However, the present invention also includes a configuration in which each one of LED boards (LEDs) is arranged as a pair at the ends of the chassis (light guide member) on the short sides thereof.

(24) Other than (23), the present invention also includes a configuration in which each one pair of LED boards (LEDs) is arranged at the ends of the chassis (light guide member) on the long sides and on the short sides thereof. Conversely, one LED board (LED) may be arranged at the end of the chassis (light guide member) on only one of the long sides or one of the short sides thereof.

(25) In the second and third embodiments, the light guide member is made of a synthetic resin. The material (substance) used in the light guide member may be other than synthetic resin material.

(26) In the foregoing embodiments, the liquid crystal panel and the chassis are vertically arranged with their short side directions aligned with the vertical direction, by way of example. The present invention also includes a configuration in which the liquid crystal panel and the chassis are vertically arranged with their long side directions aligned with the vertical direction.

(27) In the foregoing embodiments, as the switching elements of the liquid crystal display device, TFTs are used. The present invention, however, may be applied to liquid crystal display devices using switching elements other than TFTs (such as thin-film diodes (TFD)). Further, the present invention may be applied not only to a liquid crystal display device for color display but also to a liquid crystal display device for monochrome display.

(28) While in the foregoing embodiments liquid crystal display devices using a liquid crystal panel as a display panel has been described by way of example, the present invention may be applied to display devices using other types of display panels.

(29) While in the foregoing embodiments a television receiver with a tuner has been described by way of example, the present invention may be applied to a display device without a tuner.

### EXPLANATION OF SYMBOLS

10, 110, 210: Liquid crystal display device (Display device)
11, 116, 211: Liquid crystal panel (Display panel)
11a: CF substrate (Substrate)
11b: Array substrate (Substrate)
11c: Liquid crystal layer (Substance; Liquid crystal)
12, 124, 212: Backlight unit (Lighting device)
19: Color filter
22: Chassis
22a: Bottom plate (Bottom portion)
23, 223: Optical member
24, 224: LED (Light source)
27: Diffuser lens
32: Light guide member
32b: Light entrance surface
33: First reflection sheet (Reflection member)
34: Lens member
35: Second reflection sheet (Reflection member)
A1: NTSC chromaticity region
A2: EBU chromaticity region
A3: Common region
R: Red color section
G: Green Color section
B: Blue Color section
Y: Yellow Color section
T: Tuner (Reception unit)
TV: Television receiver
VC: Image conversion circuit

1. A display device comprising:
a display panel including a pair of substrates and a substance provided between the substrates, the substance having optical characteristics that vary with application of an electric field; and
a lighting device including an LED as a light source, the LED being configured to irradiate light toward the display panel, wherein
one of the substrates of the display panel includes a color filter including a plurality of blue, green, red, and yellow color sections,
the LED includes an LED element as a light emitting source and phosphors configured to light when excited by light from the LED element, the phosphors including at least two types of phosphors with different dominant emission wavelengths in a range of 480 nm to 580 nm.

2. The display device according to claim 1, wherein the at least two types of phosphors have the dominant emission wavelengths in a range of 500 nm to 560 nm.

3. The display device according to claim 2, wherein the at least two types of phosphors include a phosphor with the dominant emission wavelength of 530 nm.

4. The display device according to claim 2, wherein the at least two types of phosphors include a phosphor with the dominant emission wavelength of 540 nm.

5. The display device according to claim 2, wherein the at least two types of phosphors include a first phosphor with the dominant emission wavelength of 530 nm and a second phosphor with the dominant emission wavelength of 540 nm.

6. The display device according to claim 5, wherein the first and second phosphors are contained in substantially equal amounts.

7. The display device according to claim 1, wherein the at least two types of phosphors include a first phosphor with the dominant emission wavelength on a relatively shorter wavelength side and relatively far from 555 nm, and a second phosphor with the dominant emission wavelength on a relatively longer wavelength side and relatively close to 555 nm.

8. The display device according to claim 7, wherein the first and second phosphors are contained in substantially equal amounts.

9. The display device according to claim 1, wherein the at least two types of phosphors have a difference of 10 nm in the dominant emission wavelength.

10. The display device according to claim 1, wherein the at least two types of phosphors include a SiAlON-based phosphor.

11. The display device according to claim 10, wherein the SiAlON-based phosphor is a β-SiAlON.

12. The display device according to claim 11, wherein the β-SiAlON uses Eu as an activator.

13. The display device according to claim 10, wherein
the at least two types of phosphors include a first phosphor with the dominant emission wavelength on a relatively shorter wavelength side and a second phosphor with the dominant emission wavelength on a relatively longer wavelength side, and
the first phosphor and the second phosphor are both SiAlON-based phosphors.

14. The display device according to claim 1, wherein the phosphors further include at least one type of phosphor with the dominant emission wavelength in a range of 580 nm to 780 nm.

15. The display device according to claim 14, wherein the at least one type of phosphor has the dominant emission wavelength in a range of 600 nm to 780 nm.

16. The display device according to claim 15, wherein the at least one type of phosphor has the dominant emission wavelength in a range of 610 nm to 650 nm.

17. The display device according to claim 15, wherein the at least one type of phosphor is a CASN-based phosphor.

18. The display device according to claim 17, wherein the CASN-based phosphor is a CASN (CaAlSiN₃:Eu).

19. The display device according to claim 1, wherein the LED element has the dominant emission wavelength in a range of 380 nm to 480 nm.

20. The display device according to claim 19, wherein the LED element has the dominant emission wavelength in a range of 440 nm to 460 nm.

21. The display device according to claim 1, wherein the color filter is configured such that each chromaticity of blue, green, red, and yellow output lights obtained by passing the light from the LED through the color sections in the color filter lies outside a common region of a NTSC chromaticity region according to a NTSC standard and a EBU chromaticity region according to a EBU standard in a CIE1976 chromaticity diagram.

22. The display device according to claim 1, wherein a chromaticity region of output light obtained by passing the light from the LED through the color sections in the color filter occupies 70% or more of a NTSC chromaticity region according to the NTSC standard.

23. The display device according to claim 1, wherein
the lighting device includes a chassis that houses the LED and an optical member, the chassis including a bottom portion arranged on a side opposite to the light output side of the LED, and
the optical member is arranged on the light output side in an opposed manner with respect to both the bottom portion and the LED.

24. The display device according to claim 23, wherein the LED includes a diffuser lens on the light output side of the LED to diffuse the light from the LED.

25. The display device according to claim 1, wherein
the lighting device further includes a light guide member with an end portion opposed to the LED, and
the light guide member guides the light from the LED toward the display panel through the light guide member.

26. The display device according to claim 25, wherein
the light guide member includes an elongated light entrance surface on the end portion opposed to the LED,
the LED includes a lens member that covers the light output side of the LED and diffuses light, and
the lens member is opposed to the light entrance surface of the light guide member and curved along the longitudinal direction of the light entrance surface to be convex toward the light guide member.

27. The display device according to claim 26, wherein the lighting device further includes a reflection sheet between the LED and the light guide member along the longitudinal direction of the light entrance surface.

28. The display device according to claim 1, wherein the display panel is a liquid crystal panel including liquid crystal as the substance, the optical characteristics of which vary with application of an electric field.

29. A television receiver comprising:
the display device according to claim 1; and
a reception unit configured to receive a television signal.

30. The television receiver according to claim 29, further comprising an image conversion circuit converting a television image signal output from the reception unit into an image signal for the respective colors of blue, green, red, or yellow.
